(19) United States
(12) Patent Application Publication
(10) Pub. No.: US 2026/0340974 A1
(43) Pub. Date: Oct. 29, 2026

(54) OBJECT-CENTRIC VISION LANGUAGE MODELS

(71) Applicant: QUALCOMM Incorporated, San Diego, CA (US)

(72) Inventors: Daniel Hendricus Franciscus DIJKMAN, Haarlem (NL); Pietro MAZZAGLIA, Diemen (NL); Markus PESCHL, Amsterdam (NL); Rokas BENDIKAS, Amsterdam (NL)

(21) Appl. No.: 19/452,154

(22) Filed: Jan. 16, 2026

Related U.S. Application Data
(60) Provisional application No. 63/793,405, filed on Apr. 23, 2025.

(51) Int. Cl. G06V 10/25; B25J 9/16; G06F 40/284; G06F 40/40; G06V 10/26; G06V 10/40; G06V 10/82; G06V 20/56

(52) U.S. Cl. CPC G06V 10/25; B25J 9/163; G06F 40/284; G06F 40/40; G06V 10/26; G06V 10/40; G06V 10/82; G06V 20/56; G06V 2201/06

(57) ABSTRACT

Systems and techniques for generating content. A processor determines objects in an image, identifies a first subset of patches in the image that corresponds to an object of interest, and extracts features from each patch corresponding to the object of interest to generate visual tokens representing the object of interest. The visual tokens include a respective visual token for each patch of the first subset. The processor identifies a second subset of patches that corresponds to an additional object, extracts features from each patch of the second subset of patches corresponding to the additional object, combines the extracted features from each patch of the second subset of patches to generate a combined visual token representing the additional object, and provides the visual tokens representing the object of interest and the combined visual token representing the additional object to a machine learning model to generate output content.

### CROSS-REFERENCE TO RELATED APPLICATIONS

This application claims the benefit of U.S. Provisional Application No. 63/793,405, filed Apr. 23, 2025, which is incorporated herein by reference in its entirety.

### TECHNICAL FIELD

The present disclosure generally relates to improvements to machine learning models. For example, aspects of the present disclosure relate to systems and techniques for improving performance of vision language models, such as Vision-Language Models (VLMs), Visual Question Answering (VQA) models, and Vision-Language-Action models (VLAs).

### BACKGROUND

Machine learning systems (or models), such as neural networks (e.g., deep neural networks) are widely used for numerous applications, such as object detection, object classification, object tracking, big data analysis, generative operations (e.g., to generate images, language/text outputs, etc.), and controlling external systems, among others.

Machine learning models can be used to generate output (e.g., instructions) for controlling actions of one or more systems, such as robotics systems, vehicle systems, and/or other types of systems. For instance, in robotics applications, sensor data such as images may be provided to machine learning models to generate instructions for controlling a robotic system. In automotive applications, sensor data, such as frames (e.g., images) captured from one or more sensors, such as camera(s), radio detection and ranging (RADAR), light detection and ranging (LIDAR), etc., may be gathered, transformed, and analyzed using machine learning to detect objects and/or control a vehicle.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, the techniques described herein relate to an apparatus for generating content, including: at least one memory; and at least one processor coupled to the at least one memory and configured to: determine a plurality of objects in an image of a scene; identify a first subset of patches from a set of patches of the image that corresponds to an object of interest from the plurality of objects; extract features from each patch of the first subset of patches corresponding to the object of interest to generate visual tokens representing the object of interest, wherein the visual tokens include a respective visual token for each patch of the first subset of patches; identify a second subset of patches from the set of patches that corresponds to an additional object of the plurality of objects; extract features from each patch of the second subset of patches corresponding to the additional object; combine the extracted features from each patch of the second subset of patches to generate a combined visual token representing the additional object; and provide the visual tokens representing the object of interest and the combined visual token representing the additional object to a machine learning model to generate output content.

In some aspects, the techniques described herein relate to a method for generating content, the method including: determining a plurality of objects in an image of a scene; identifying a first subset of patches from a set of patches of the image that corresponds to an object of interest from the plurality of objects; extracting features from each patch of the first subset of patches corresponding to the object of interest to generate visual tokens representing the object of interest, wherein the visual tokens include a respective visual token for each patch of the first subset of patches; identifying a second subset of patches from the set of patches that corresponds to an additional object of the plurality of objects; extracting features from each patch of the second subset of patches corresponding to the additional object; combining the extracted features from each patch of the second subset of patches to generate a combined visual token representing the additional object; and providing the visual tokens representing the object of interest and the combined visual token representing the additional object to a machine learning model to generate output content.

In some aspects, the techniques described herein relate to a non-transitory computer-readable medium is provided that has stored thereon instructions that, when executed by one or more processors, cause the one or more processors to: determine a plurality of objects in an image of a scene; identify a first subset of patches from a set of patches of the image that corresponds to an object of interest from the plurality of objects; extract features from each patch of the first subset of patches corresponding to the object of interest to generate visual tokens representing the object of interest, wherein the visual tokens include a respective visual token for each patch of the first subset of patches; identify a second subset of patches from the set of patches that corresponds to an additional object of the plurality of objects; extract features from each patch of the second subset of patches corresponding to the additional object; combine the extracted features from each patch of the second subset of patches to generate a combined visual token representing the additional object; and provide the visual tokens representing the object of interest and the combined visual token representing the additional object to a machine learning model to generate output content.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example of an implementation of a system-on-a-chip (SoC), in accordance with aspects of the present disclosure;

FIG. 2 is a diagram illustrating an example of a machine learning system, in accordance with aspects of the present disclosure;

FIG. 3A is a diagram illustrating an example of an example machine learning system, in accordance with aspects of the present disclosure;

FIG. 3B is a diagram illustrating a visual depiction of various objects, masks, and tokens to provide additional context for the description of a feature pooling model of the machine learning system of FIG. 3A;

FIG. 4A is a diagram illustrating an example of a process for using a machine learning system, in accordance with aspects of the present disclosure;

FIG. 4B is a diagram illustrating an example of an input image overlaid with patch boundaries, in accordance with aspects of the present disclosure;

FIG. 5 is a diagram illustrating a visual depiction of various images and patches to provide context for a description of using an object history, in accordance with aspects of the present disclosure;

FIG. 6 is a flow diagram illustrating an example of a process for machine learning, in accordance with aspects of the present disclosure;

FIG. 7 is a block diagram illustrating an example of a deep learning neural network that can be used to perform various tasks, according to some aspects of the disclosed technology;

FIG. 8 is a block diagram illustrating an example of a convolutional neural network (CNN), according to various aspects of the present disclosure;

FIG. 9 is a block diagram illustrating a multimodal generative machine-learning system for generating natural language responses based on natural language input from a prompt and any additional information;

FIG. 10 includes an example machine-learning model that may be used in various aspects of the present disclosure;

FIG. 11 is a block diagram of an example transformer in accordance with some aspects of the disclosure; and

FIG. 12 is a block diagram illustrating an example computing-device architecture of an example computing device which can implement the various techniques described herein.

### DETAILED DESCRIPTION

Certain aspects and aspects of this disclosure are provided below. Some of these aspects and aspects may be applied independently and some of them may be applied in combination as would be apparent to those of skill in the art. In the following description, for the purposes of explanation, specific details are set forth to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. Various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As previously mentioned, machine learning models can be used for various applications. For instance, machine learning models can be used to process images and/or user queries to generate control signals to control a system (e.g., a robotic system, a vehicle system, and/or other type of system) to perform a task described in the user queries.

However, in certain cases, machine learning can become computationally complex. For instance, the computational complexity of a machine learning system increases with a length of input tokens provided to the machine learning system. With respect to transformer models, the computational complexity is quadratic relative to the number of tokens. Some types of inputs to the model can also further increase complexity.

For example, images may require a large number of tokens to be represented in naive tokenization schemes. Further, training datasets may be very large. As a result, training requires large amounts of computation on a server system and inference also requires large amounts of edge-computing power in addition to memory bandwidth constraints.

Systems, apparatuses, electronic devices, methods (also referred to as processes), and computer-readable media (collectively referred to herein as “systems and techniques”) are described herein for improving performance of machine learning systems (also referred to as machine learning models). For example, aspects of the present disclosure relate to systems and techniques for improving performance of Vision-Language Models (VLMs) and Vision-Language-Action models (VLAs).

In some aspects, the systems and techniques may be used to control operation of machines based on images of scenes in which the machines are operating. For example, the systems and techniques may process visual information from cameras or other imaging sensors to generate commands for robotic systems, autonomous vehicles, or other automated machinery. The systems and techniques may analyze images of a robotic workspace to identify objects and generate instructions for controlling robotic elements.

While examples described herein refer to machine learning systems (or models) that control robotics systems for illustrative purposes, the systems and techniques can be applied to any type of system (e.g., vehicle systems, extended reality (XR) systems such as a virtual reality (VR), augmented reality (AR), and/or mixed reality (MR) headset, etc.) that can perform actions based on output from the machine learning systems. For instance, the systems and techniques may be used in end-to-end learning for autonomous driving and/or VLMs (e.g., question-answering models). For example, the systems and techniques may process images from vehicle-mounted cameras to generate steering, acceleration, or braking commands for autonomous navigation.

As further explained below, the systems and techniques use improved machine learning techniques to maintain or increase a number of tokens representing an object of interest within an image, while reducing a number of tokens that represent objects other than the object of interest (e.g., less relevant or irrelevant objects). Examples of an object of interest include a robotic element (such as a gripper and/or a robot arm), a vehicle on a road, a pedestrian on a road, etc.

The following non-limiting example is introduced for discussion purposes. A computing device accesses an image and identifies objects within the image. The device identifies a first set of patches within the image that corresponds to an object of interest (e.g., an actionable, or primary object) and a second set of patches that corresponds to one or more additional (e.g., other objects) represented in the image. The device extracts first features from the first set of patches that represent the object of interest. The first features may be represented as a set of visual tokens. The device extracts second features from the second set of patches. The second features may be represented as a combined visual token that corresponds to the additional objects. The device combines the visual tokens and the combined visual token and provides the combined tokens to a machine learning model to generate output content. In some cases, output tokens can represent control signals that can be provided to a system (e.g., a robotic system, a vehicle system, or other type of system).

The systems and techniques can improve the efficiency of machine learning systems. For example, by reducing tokens used as input to a machine learning system, the systems and techniques provide technical improvements including with respect to both training and inference phases of the machine learning system. For instance, the systems and techniques can enable training of systems on state-of-the-art robotics datasets on a single node of a graphics processor instead of eight nodes of a graphics processor. The systems and techniques can also improve training time for a given training example. Such improvements can enable improved performance of downstream applications.

The present disclosure addresses the technical problem of computational complexity in machine learning systems, particularly when processing visual data.

Conventional approaches for processing images in machine learning models (e.g., VLMs and VLAs) require representing images using a large number of tokens, with each patch of an image typically corresponding to a separate token. This approach results in significant computational overhead during both training and inference phases of operation of the machine learning models, as the computational complexity increases quadratically with the number of input tokens in transformer-based models.

The technical solution provided herein involves a selective tokenization approach that selectively determines tokens to process based on the relevance of the tokens to objects of interest. The approach determines a plurality of objects within an image of a scene and identifies different subsets of patches corresponding to different objects. For an object of interest from among the plurality of objects, a first subset of patches is identified, and features are extracted from each patch of this first subset to generate a first set of visual tokens, with each patch maintaining its own respective visual token representation.

For at least some additional objects of the plurality of objects, a second subset of patches is identified (e.g., one subset for each additional object), and features are extracted from the patches of the second subsets (e.g., one feature for each object).

However, rather than generating separate tokens for each patch for each object, the extracted features from all patches of each the second subsets are combined to generate a single combined visual token representing each additional object. In other words, the systems and techniques generate one token for each object. This approach maintains detailed representation for objects of interest while reducing the token count for other objects in the scene.

The visual tokens representing the object of interest and the combined visual token representing the additional object are then provided to a machine learning model (e.g., an LLM, a VLM and/or a VLA) to generate output content. This selective approach to tokenization achieves a technical effect of reducing the overall number of tokens processed by the machine learning model while preserving sufficient detail for objects that may require more precise analysis or control, thereby improving computational efficiency without compromising the quality of the generated output content.

Various aspects of the present disclosure will be described with respect to the figures.

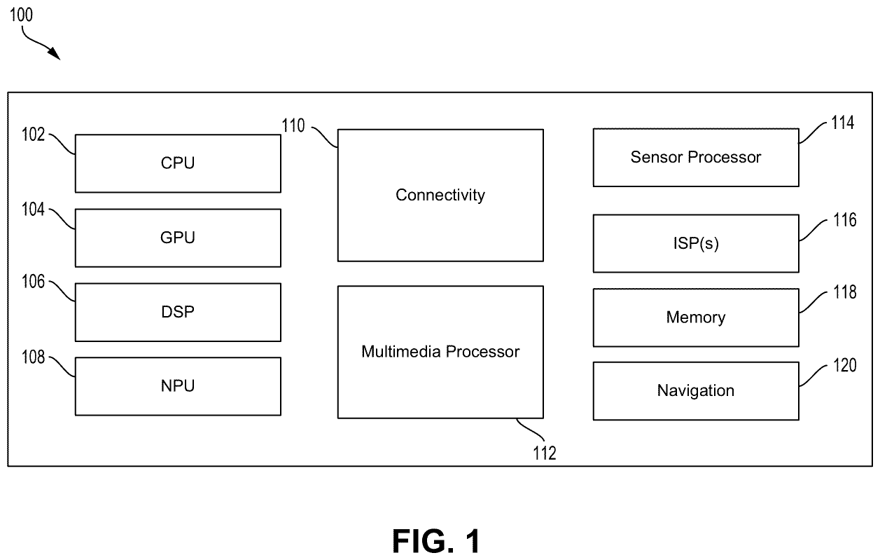

FIG. 1 is a diagram illustrating an example of an implementation of a system-on-a-chip (SOC) 100, which may include a central processing unit (CPU) 102 or a multi-core CPU, configured to perform one or more of the functions described herein.

Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize audio signals. In one implementation, the NPU is implemented in the CPU 102, DSP 106, and/or GPU 104. The SOC 100 may also include one or more sensors 114 such as but not limited to one or more microphones, image signal processors (ISPs) 116, and/or storage 120.

The SOC 100 may be based on an ARM instruction set. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 and/or components thereof maybe configured to generate explanations for actions performed (e.g., to be performed, predicted to be performed, etc.) by a machine learning model (or machine learning system). The explanations can be one or more of a text-based description, set of instructions to perform a sub-task or task, etc. according to aspects of the present disclosure discussed herein. The SOC can be used to operate various machine learning models for image processing, text processing, feature extraction, signal controls generation, etc. For example, SOC 100 and/or components thereof may be configured to perform processing techniques such as but not limited to: segment shifting, shuffle correlation, gain shifting, segment masking, and additional processing techniques.

SOC 100 can be part of a computing device or multiple computing devices. In some examples, SOC 100 can be part of an electronic device (or devices) such as an audio recording device, camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 11, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. An example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding the output back to the input to help in predicting an outcome of the layer. A GAN is a form of generative neural network model (or system) that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

For example, the use of recurrent connections and/or temporal information in a machine learning model for audio processing, such as denoising of audio signals, can be used to preserve low-frequency audio signals in audio signals with wind noise, to achieve higher quality audio signals. Various recurrent architectures (e.g., RNNs) that include one or more recurrent cells among the feed-forward layers of the network can be used to perform audio processing operations to generate processed output audio signals having a relatively high quality. For example, recurrent cells can be implemented using a vanilla-RNN architecture, a Conv-GRU (Gated Recurrent Unit) architecture, a Conv-LSTM (Long Short-Term Memory) architectures, among various others.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep-learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of audio can benefit from first learning to recognize individual spoken words, instruments in music, etc. These features may be combined at higher layers in different ways to recognize sounds such as speech, instruments, wind noise, etc.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

Further description of machine learning model architecture is provided herein.

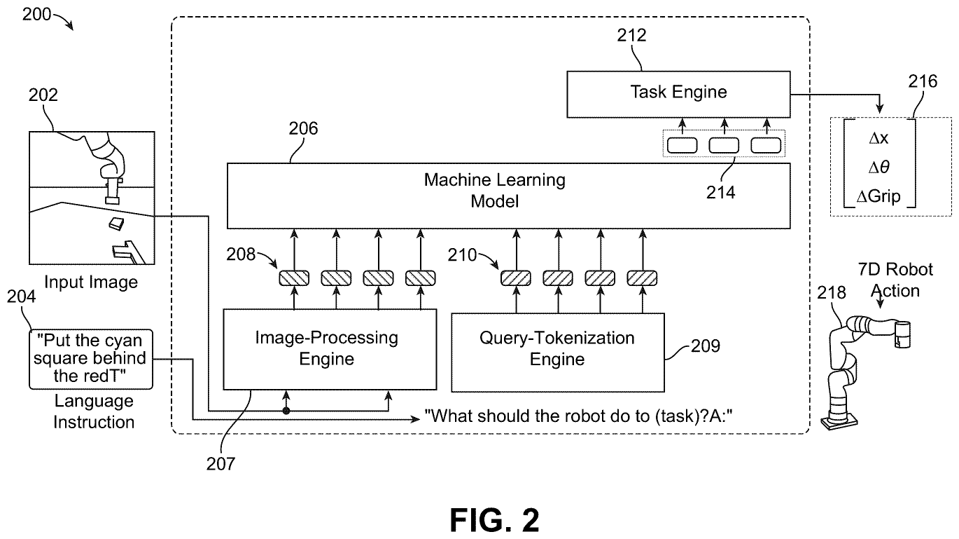

FIG. 2 is a diagram illustrating an example of a machine learning model system 200, in accordance with aspects of the present disclosure. The machine learning model system 200 includes a machine learning model 206, an image-processing engine 207, a query-tokenization engine 209, and a task engine 212. System 200 can be used to generate output (e.g., instructions) for controlling actions of one or more systems, such as robotics systems, vehicle systems, and/or other types of systems.

In some examples, the example machine learning model system 200 can be part of a robotic system to perform tasks. For example, the example machine learning model system 200 can include a robotic arm 218, a camera to receive an image 202 (or series of images such as a video, video stream, etc.), and an input/output (I/O) device to receive a user query 204. The user query can be a text-based user prompt requesting the robotic system or machine learning model system 200 perform a task (e.g., move an object, clear a table, sort a set of objects, etc.).

The image-processing engine 207 can process the image 202 to generate a set of tokens 208. In some examples, the image-processing engine 207 can be a machine learning model (or a plurality of machine learning models) for processing images to extract features from the image 202 and to generate the set of tokens 208 associated with the features. For instance, the image-processing engine 207 can be a system of multiple machine learning models, such as a machine learning models to perform image segmentation, image classification (e.g., to classify one or more objects in the image 202), a machine learning model to perform feature extraction of images, and a machine learning model to project extracted features in a different space (e.g., to convert or project an output from the machine learning models, such as an image segmentation output, an image classification output, extracted features, etc., to the set of tokens). In further examples, the image-processing engine 207 can be an algorithm, application, service, etc. for extracting the features from the image 202 and generating the set of tokens 208 associated with the features. In an example, the image-processing engine 207 includes one or more of a multi-layer perceptron (MLP) projection model, a Self-supervised Vision Transformer Model such as “DinoV2” and a multimodal image-text model such as “SigLIP.”

In some examples, the aforementioned image processing techniques can be performed by the same machine learning model (e.g., the image-processing engine 207), or different components of the same machine learning model. In some aspects, the image-processing engine 207 can include a first neural network or a first set of neural networks that can perform feature extraction to determine or extract features from the image 202 and/or perform one or more image processing operations on the image 202, such as image segmentation, image classification, etc. In some examples, the first neural network or the first set of neural networks can include a DinoV2 neural network model, a Sigmoid Language Image Pre-training (SigLIP) neural network model, a Contrastive Language-Image Pre-Training (CLIP) neural network model, any combination thereof, and/or other type of machine learning model.

The image-processing engine 207 can also include a second neural network referred to as a projector (e.g., a multi-layer perceptron (MLP) projector or other type of projector) that can generate a set of tokens 208 for input to the first machine learning model based on processing the output from the first neural network or the first set of neural networks. In some cases, the projector can perform dimensionality reduction on features of the image 202. For example, image-processing engine 207 may adjust (e.g., project) image features from an image-embedding space to a text-embedding space. For instance, the projector may transform visual features extracted from the image 202 into a format compatible with text-based processing systems. In some aspects, this transformation involves mapping high-dimensional visual representations to a shared embedding space where both visual and textual information can be processed together. The projector may use learned transformations to convert image-derived features into token representations that can be interpreted by language models or other text-processing components. In some cases, this projection process enables the integration of visual information with textual instructions or queries, allowing the system to process multimodal inputs effectively. In some examples, the projector can be a separate neural network from the image-processing engine 207.

As noted above, the output of the projector can be the set of tokens 208 associated with the processed image (e.g., a tokenized representation of image 202). The set of tokens 208 associated with the processed image can be a first subset of a set of input tokens received by the machine learning model 206.

The query 204 may include text instructions for controlling or directing a system, such as the robotic arm 218. These instructions may take various forms, including a single instruction (e.g., “pick up the red block”), a list of sequential instructions (e.g., “first pick up the red block, then place it on the blue surface, then move to the starting position”), or more complex directives that include rules, priorities, or conditional logic (e.g., “sort objects by color, prioritizing red objects first, but avoid touching any fragile items”). The instructions may specify particular actions, target objects, spatial relationships, timing constraints, or other parameters relevant to the task being performed by the system.

In some cases, the query 204 may originate as spoken input from a user and be converted into text through a speech-to-text (STT) model or automatic speech recognition system. The STT model may process audio signals containing the user's verbal instructions and generate corresponding text representations that can be processed by the query-tokenization engine 209. In other cases, the query 204 may be provided as a text file, entered through a user interface, transmitted from another system or application, or supplied through various other text input methods. The query 204 may also include metadata or formatting information that provides additional context for interpreting the instructions, such as urgency levels, safety constraints, or references to specific objects or locations within the operating environment.

The query-tokenization engine 209 can receive the user query 204. The query-tokenization engine 209 can process the user query 204 to generate a tokenized representation of the user query 204 (e.g., tokens 210). For example, the tokenized representation can be a set of tokens 210. In some examples, the query-tokenization engine 209 can be a machine learning model. The query-tokenization engine 209 can be an algorithm, application, service, etc. for processing the user query 204 to generate a set of tokens 210 which can be received as input by the machine learning model 206. In an example, the query-tokenization engine 209 is a “Llama” tokenizer.

The machine learning model 206 can receive the tokenized representation of the image 202 (e.g., tokens 208) and the tokenized representation of the user query 204 (e.g., tokens 210). For example, machine learning model 206 may receive a set of input tokens including a first subset of tokens (e.g., associated with the image 202) and a second subset of tokens (e.g., associated with the user query 204). The machine learning model 206 can process the input tokens (including tokens 208 and tokens 210) to generate a set of output tokens 214. In some examples, the machine learning model 206 can be a neural network, transformer-based architecture model, a large language model (LLM), etc. The output tokens 214 can represent a prediction of the actions the machine learning model 206 (or a robotic system including the machine learning model 206) should perform to complete a task. For example, the output tokens 214 can include instructions associated with performance of a task requested to be performed in the user query 204.

The output tokens 214 can be received by the task engine 212. In some examples, the task engine 212 is a machine learning model for de-tokenizing the output tokens 214 to generate a set of control signals 216 for controlling a robot (e.g., the robotic arm 218). In some examples, the task engine 212 can generate a set of instructions for completing the task (e.g., the task requested to be performed in the user query 204) based on the output tokens 214. In further examples, the machine learning model 206 outputs the control signals in a format readable to a robot without requiring detokenization.

In some cases, hidden states may be used to generate instructions. In an example, hidden states of the model (e.g., features output by intermediate layers of the machine learning model) can be processed to generate instructions for performing a task or a sub-task of the task requested to be performed in the user query 204. In such an example, the instructions can include a text-based description of the sub-task the machine learning model 206 predicts should be performed as part of a sequence of sub-tasks to perform the overall task (e.g., the task requested to be performed in the user query 204). In some cases, these descriptions can help explain operations.

In an example, a task for sorting objects into bins using the robotic arm 218 can be represented as a sequence or series of sub-tasks which when performed result in performance of the overall task. In such an example, sorting objects into bins can include identifying a bin associated with an object, positioning the arm at a location associated with the object, adjusting grip of a manipulator to secure the object, lifting the object, positioning the arm at a location associated with the bin, and releasing the grip of the manipulator to drop the object in the bin. In such an example, the output network can adjust as sub-tasks of the overall task are performed based on changes in the hidden states of the first machine learning model as the task is performed.

For example, the machine learning model 206 can receive tokens associated with a sequence of images (e.g., a video) of an environment in which the task from the user query 204 is to be performed. The input tokens representing the sequence of images can be received as inputs to the machine learning model 206. Processing of the sequence of images can result in changes to hidden states of the machine learning model 206 because the machine learning model 206 the tokens received as input to the machine learning model 206 can be different as a scene captured in the sequence of images changes (e.g., as objects are moved, as the robotic arm 218 moves, etc.) In some cases, hidden states of the machine learning model 206 can update a description (e.g., instructions to perform one or more sub-tasks) based on the hidden states.

In some cases, the techniques discussed with respect to FIG. 2 can have a large computational overhead. As discussed above, representing an input image (e.g., input image 202) can require a large number of tokens, resulting in increased computational overhead during training and/or inference for machine learning model 206. For example, the total number of tokens 208 may be large (e.g., one token for each of 16×16 patches of input image 202). The large number of tokens may result in significant computational costs to train machine learning model 206 and/or to operate machine learning model 206 at inference.

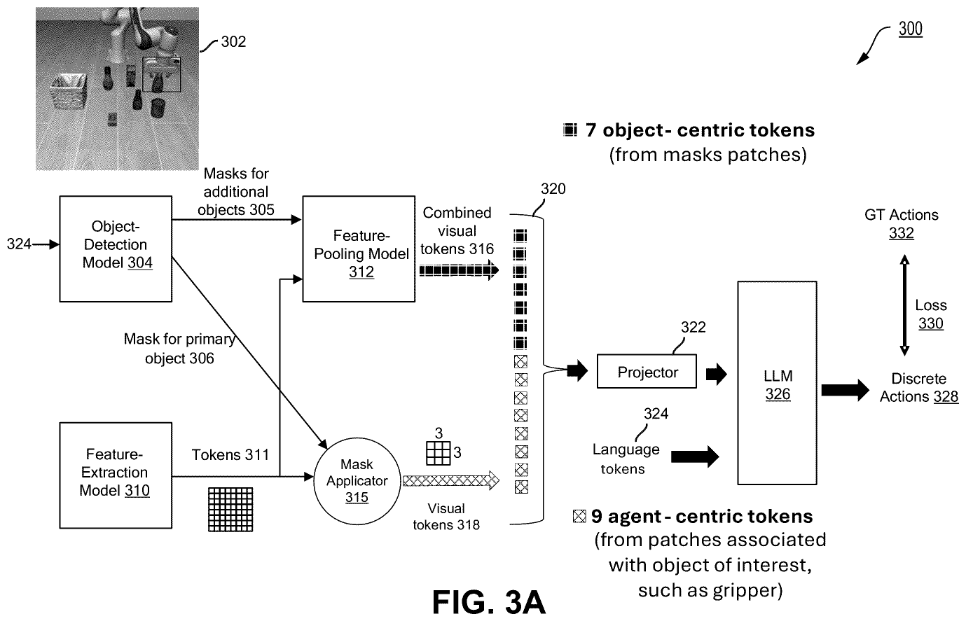

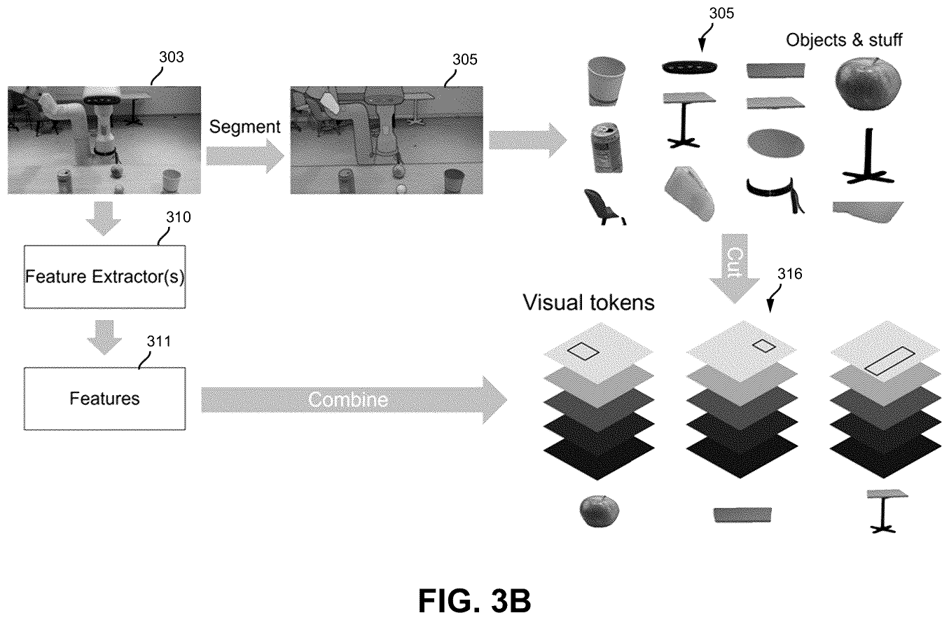

In contrast, the systems and techniques discussed below, such as in FIG. 3A, may decrease the total number of tokens (e.g., image-based tokens) processed by a machine-learning model. For instance, the systems and techniques may maintain or increase a number of tokens that represent an object of interest within an image while reducing a number of tokens that represent additional objects (e.g., not the object of interest). By reducing the number of tokens that represent the additional objects, the systems and techniques may decrease the total number of tokens (e.g., image-based tokens) to be processed by the machine learning model. Decreasing the total number of tokens (e.g., image-based tokens) processed by the machine learning model may decrease the computational overhead (e.g., relative to machine learning system 200).

FIG. 3A is a diagram illustrating an example of an improved machine learning system 300, in accordance with aspects of the present disclosure. In the example depicted in system 300, object-detection model 304 may analyze an image 302 to identify masks corresponding to objects (e.g., additional-object masks 305 and primary-object mask 306). Additionally, feature-extraction model 310 may identify features corresponding to patches (e.g., areas) of the image. The features may be converted or combined into tokens (e.g., feature tokens 311). Additionally, mask applicator 315 may derive visual tokens 318 that represent an object of interest within the image 302. Feature-pooling model 312 may determine combined visual tokens 316 that represent additional (e.g., other) objects or areas of the image. Combined visual tokens 316 and visual tokens 318 may be combined into a token representation 320, which may be projected (e.g., by projector 322) and used in downstream applications such as using machine learning (e.g., large language model 326) to determine actions (e.g., discrete actions 328) to control external devices.

System 300 may access image 302 and provide image 302 to object-detection model 304. The object-detection model 304 can process the image 302 to identify (e.g., by performing semantic or image segmentation, object detection, or other technique) one or more objects represented within image 302.

Object-detection model 304 may generate primary-object mask 306. Primary-object mask 306 may indicate positions (e.g., pixel positions) of a primary object in input image 302. For instance, primary-object mask 306 may indicate which pixels of input image 302 represent the primary object.

Additionally, object-detection model 304 may generate additional-object masks 305. Additional-object masks 305 may indicate positions (e.g., pixel positions) of additional objects in input image 302. For instance, additional-object masks 305 may indicate which pixels of input image 302 represent each of a number of additional objects.

The system 300 may also provide image 302 to feature-extraction model 310.

The feature-extraction model 310 can process image 302 to identify (e.g., determine, generate, etc.) patches (areas) of image 302. Further, feature-extraction model 310 can extract features from each of the patches. In some cases, operations performed by object-detection model 304 and feature-extraction model 310 may execute in parallel. In some cases, object-detection model 304 and feature-extraction model 310 may share a common backbone.

Object-detection model 304 can include a machine learning system or model (e.g., a neural network) trained to identify one or more objects within image 302 and to generate indications (e.g., bounding boxes, masks such as segmentation masks or instance masks, and/or other type of indication) that indicate locations of the objects in image 302. Of the various objects identified in image 302, one or more objects may be identified as objects of interest. The remaining additional objects may also be identified. Different techniques may be used by object-detection model 304 to identify object(s). For instance, object-detection model 304 may be a segmentation model configured to generate a mask (e.g., a semantic segmentation mask) for the image, with the mask indicating the various objects in image 302 (e.g., each pixel in the mask can include one or more values corresponding to a particular object for which that pixel represents). In some examples, the object-detection model 304 is an instance of the “FTDinosaur” model.

As depicted in FIG. 3A, image 302 includes various objects including objects on a surface and a robot arm with a gripper on the end of the arm. In the example of FIG. 3A, object-detection model 304 identifies the gripper as an object of interest and the other objects in the scene as additional objects. Additionally, or alternatively, object-detection model 304 may identify objects within a predetermined distance (either in pixel-space in input image 302 or in 3D space) of the gripper as objects of interest. For example, object-detection model 304 may determine that any object within 10 centimeters of the gripper is an object of interest (in place of or in addition to the gripper).

Object-detection model 304 outputs additional-object masks 305 corresponding to the one or more additional objects and primary-object mask 306 corresponding to the object of interest (e.g., the gripper). In some cases, primary-object mask 306 identifies two or more objects of interest. For example, the object(s) of interest may include any object(s) that may require additional attention or focus from the system. In some aspects, a single mask can be output that includes an indication (e.g., pixel values) of the one or more additional objects and the gripper.

In some aspects, other and/or additional models may be used for object detection. For instance, in some cases, a first model may be used to identify additional-object masks 305 and a second model may be used to identify primary-object mask 306. Further, in some cases, one or more objects may be identified by an external system and/or by a user device.

Feature-extraction model 310 can include a machine learning system or model (e.g., a neural network) trained to divide image 302 into patches (e.g., areas) and/or from the patches, identify representative features or tokens. For a given patch, one or more tokens may be assigned or generated (e.g., one token per patch). In some examples, image 302 is divided into a grid of patches, where each patch represents an area of the image (e.g., a grid of 16×16 patches, corresponding to 16 rows and 16 columns of patches, for a total of 256 patches per image). Each patch can include multiple pixels. A token for a particular patch can include features that represent or otherwise correspond to portion of the image included in the patch (e.g., pixels of the image that are within the patch). For example, the features corresponding to a token can be an N-dimensional vector (e.g., a 256-dimensional vector) including values representing the patch. While square patches are depicted in FIG. 3A, patches of other shapes are possible. Examples of feature-extraction model 310 include a pre-trained DinoV2 (ViT) model and a pre-trained SigLIP (ViT) model. For instance, in some examples, the feature-extraction model 310 can include one or both of the pre-trained DinoV2 (ViT) model and the pre-trained SigLIP (ViT) model. Other models, including other transformer-based models, may be used. In some cases, the feature-extraction model 310 can be similar to and perform similar operations as the image-processing engine 207 of FIG. 2.

Feature-pooling model 312 can obtain additional-object masks 305 and tokens 311. Feature-pooling model 312 can identify, for each additional object (each object other than the object of interest), corresponding tokens (and thus features) from tokens 311 that correspond to patches that overlap with each additional object. For instance, if two patches overlap with a mask of a particular object, then the two tokens that correspond to the two patches are obtained for the particular object.

The Feature-pooling model 312 can combine (e.g., using one or more combining techniques) all the tokens related to each of the additional objects to reduce the representation of each of the objects to one token (referred to as an object-centric token representing a particular object). For instance, a combining technique can be performed on the features corresponding to extracted tokens for an object to create a combined token (e.g., a combined visual token) for the object. The process can be performed on all the patches corresponding to each of the identified objects to generate a respective combined token for each of the identified objects.

In some examples, the one or more combining techniques may include averaging (e.g., averaging all of the tokens that correspond to the object), max-pooling operations, average-pooling operations, transformer neural network operations (e.g., cross-attention, self-attention, etc.), etc. Max-pooling is a technique used to reduce the dimensionality of features (e.g., feature maps) while preserving important information. Average pooling is a technique used to compute an average value of the elements within each pooling region of an input (e.g., input features from a previous layer of a machine learning model or system). In some cases, the combining may be implemented by a small transformer model. Other techniques that reduce a number of tokens representing a given object may be used as the combining technique. In some cases, two or more objects may be represented by a single token.

Feature-pooling model 312 can then output combined visual tokens 316. The combined visual tokens 316 are object-centric tokens, with each token corresponding to an object of the additional objects identified in the image. In the example of FIG. 3A, seven object-centric tokens are generated for the seven additional objects indicated in the additional-object masks 305. In such an example, for each object with a certain number of patches, the multiple tokens corresponding to the object are reduced to one token for the object.

In some aspects, feature-pooling model 312 may determine a number (e.g., seven) of objects for which to generate combined visual tokens 316. For example, in some aspects, feature-pooling model 312 may cluster patches into a predetermined number (e.g., seven) of regions. In other aspects, system 300 may implement a machine-learning model trained to determine the number of objects for which to generate tokens, and system 300 may adapt the number of objects and the object masks to the language tokens 324. Other objects detected by object-detection model 304 may not be represented by combined visual tokens 316. Feature-pooling model 312 (or object-detection model 304) may determine for which objects (of all the objects detected by object-detection model 304) to generate combined visual tokens 316. For instance, in some aspects, object-detection model 304 may send the largest predetermined number (e.g., seven) of masks to Feature-pooling model 312 and Feature-pooling model 312 may generate one of combined visual tokens 316 for each of the masks. As another example, Feature-pooling model 312 may determine the predetermined number (e.g., seven) closest objects to the primary object and generate one of combined visual tokens 316 for each of the closest predetermined number of objects.

In some aspects, Feature-pooling model 312 may combine all of tokens 311 into a single token to represent an entirety of image 302. In this case, an additional single token is used that summarizes the entire image 302. The additional token may be added to combined visual tokens 316 or may be output as the only token in combined visual tokens 316.

FIG. 3B is a diagram illustrating a visual depiction of various objects, masks, and tokens to provide additional context for the description of Feature-pooling model 312 of machine learning system 300. For example, an example input image 303 may be segmented (e.g., by object-detection model 304) to generate masks (e.g., additional-object masks 305). The various additional-object masks 305 may segment input image 303 into segments, with each segment representing a respective object. For example, each mask may indicate pixels of input image 303 that represent a respective object.

Additionally, feature-extraction model 310 may generate feature tokens 311 based on input image 303. In some aspects, input image 303 may be divided into patches. For example, input image 303 may be divided into a 16×16 grid of patches. Feature-extraction model 310 may generate one feature per patch. Accordingly, feature tokens 311 may include 256 features. As described with regards to mask applicator 315, a number of these may be selected by mask applicator 315 as visual tokens 318. For example, a number of features related to an object of interest may be selected as visual tokens 318.

Feature-pooling model 312 may combine additional-object masks 305 with feature tokens 311 to generate combined visual tokens 316. For example, Feature-pooling model 312 may identify features from feature tokens 311 that correspond to each of the masks in additional-object masks 305 by performing a spatial-correspondence analysis between the patch locations and the masks. For each mask in additional-object masks 305, Feature-pooling model 312 may determine which patches from the grid of patches (e.g., the 16×16 grid) spatially overlap with or fall within the boundaries of that particular mask.

In some aspects, Feature-pooling model 312 may use pixel-level mapping to identify patches that have any portion overlapping with a mask region. For instance, if a mask indicates that pixels at certain coordinates belong to a particular object, Feature-pooling model 312 may identify all patches that contain those pixel coordinates. In some cases, Feature-pooling model 312 may apply a threshold-based approach, where a patch is considered to correspond to a mask if a predetermined percentage (e.g., 50% or more) of the patch area overlaps with the mask region.

Once Feature-pooling model 312 has identified the relevant feature tokens 311 for each mask, feature tokens 311 combines all features corresponding to a given mask to generate a single combined visual token for mask object (e.g., generating a single token for each single object). For each additional object represented by a mask in additional-object masks 305, Feature-pooling model 312 may aggregate the features from all corresponding patches using various combination techniques. In some aspects, Feature-pooling model 312 may compute an element-wise average of all feature vectors corresponding to patches that overlap with a particular mask, resulting in a single averaged feature vector that represents the entire object. Alternatively, Feature-pooling model 312 may apply max-pooling operations, where the maximum value across all corresponding feature vectors is selected for each dimension. Alternatively, Feature-pooling model 312 may use attention-based mechanisms to weight the contribution of different patches based on their relevance to the object. In some cases, Feature-pooling model 312 may employ a small neural network or transformer module to learn an optimal combination strategy for merging the multiple patch-level features into a single object-level representation, thereby generating one combined visual token per object mask.

Returning to FIG. 3A, mask applicator 315 can receive tokens 311 and the primary-object mask 306 that represents one or more objects of interest. Mask applicator 315 can process the tokens 311 and the primary-object mask 306 to generate visual tokens 318. Visual tokens 318 represent tokens that correspond to primary-object mask 306, which corresponds to the object of interest. For example, visual tokens 318 may be, or may include tokens for patches representing the object of interest. The visual tokens 318 may be from a 3×3 grid of patches (with one token per patch in the 3×3 grid for a total of nine tokens). In the example of FIG. 3A, nine agent-centric tokens are created from the object of interest (the robot gripper in FIG. 3A). Compression is minimal or zero, resulting in a high quality representation of the patches that correspond to the object of interest.

In some aspects, the grid of patches may include other numbers of patches (such as 5×5 or 7×7). The grid of patches may be centered on the object of interest or on a particular portion of the object of interest (e.g., a space between pincers of a gripper). In some aspects, the grid of patches may be designed to include objects close to the object of interest. For example, the grid of patches may be designed to include an object that the gripper is approaching, for instance, to grip.

A token representation 320 includes visual tokens 316 and visual tokens 318. In the example case depicted by FIG. 3A, token representation 320 includes sixteen total tokens, including the nine tokens from the nine patches overlapping with the object of interest and seven object-centric tokens corresponding to the additional objects.

Token representation 320 may be provided to projector 322. The projector 322 can process the tokens of the token representation 320 to place the tokens in a format that can be processed by a large language model (LLM) 326, such as in a text-token format. Projector 322 may map high-dimensional visual representations to a shared embedding space where both visual and textual information can be processed together. The projector 322 may use learned transformations to convert image-derived features (e.g., combined visual tokens 316 and visual tokens 318) into token representations that can be interpreted by language models or other text-processing components. In some cases, this projection process enables the integration of visual information with textual instructions or queries, allowing the system to process multimodal inputs effectively.

Language tokens 324 may be text tokens representing instructions provided to the system. The instructions may be similar to query 204, which can include text-based directives for controlling or directing a system, such as commands for robotic manipulation tasks. The instructions may take various forms, including single commands, sequential task lists, or complex directives that specify particular actions, target objects, spatial relationships, timing constraints, or other parameters relevant to the task being performed. The instructions may be encoded by a text encoder, such as query-tokenization engine 209, which processes the textual input to generate tokenized representations suitable for processing by the machine learning model. In some cases, the text encoder may convert natural language instructions into numerical token representations that can be combined with visual tokens for multimodal processing by the large language model 326.

The output of the projector 322 and language tokens 324 can be provided as input to large language model (LLM) 326. In some aspects, LLM 326 may be a Vision-Language-Model (VLM).

LLM 326 may output various outputs including one or more discrete actions 328. Discrete actions 328 may be used to control one or more external devices such as robotic devices. In some cases, representative actions (ground truth (GT) actions 332) are compared with the discrete actions 328 to generate a loss 330. The loss 330 may be used to train and/or otherwise improve the system (e.g., through backpropagation based on gradient descent). For example, large language model 326 may be trained based on loss 330.

Using the systems and techniques discussed above, detail can be maintained where necessary, for example in areas of an image that depict an object of interest in an image (e.g., a robot arm gripper or a target vehicle in a foreground view of a tracking or ego vehicle), while reducing a number of tokens used to represent additional objects in the image. For example, whereas machine learning system 200 may cause machine learning model 206 to process 256 unique visual tokens (e.g., tokens 208) (e.g., based on a 16×16 grid of patches), machine learning system 300 may cause large language model 326 to process 16 unique visual tokens (e.g., combined visual tokens 316 and visual tokens 318).

Thus, machine learning system 300 reduces a computational complexity for downstream training and/or inference operations (e.g., for processing of token representation 320 by large language model 326). Reducing the computational complexity for large language model 326 can enable increased performance for large language model 326 especially on edge devices, while maintaining sufficient detail in representations of the object of interest.

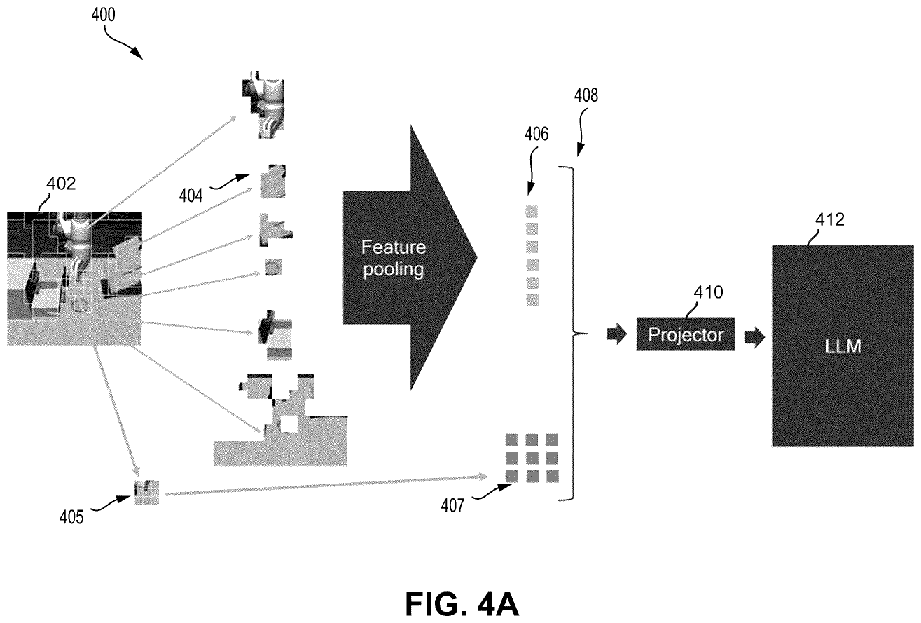

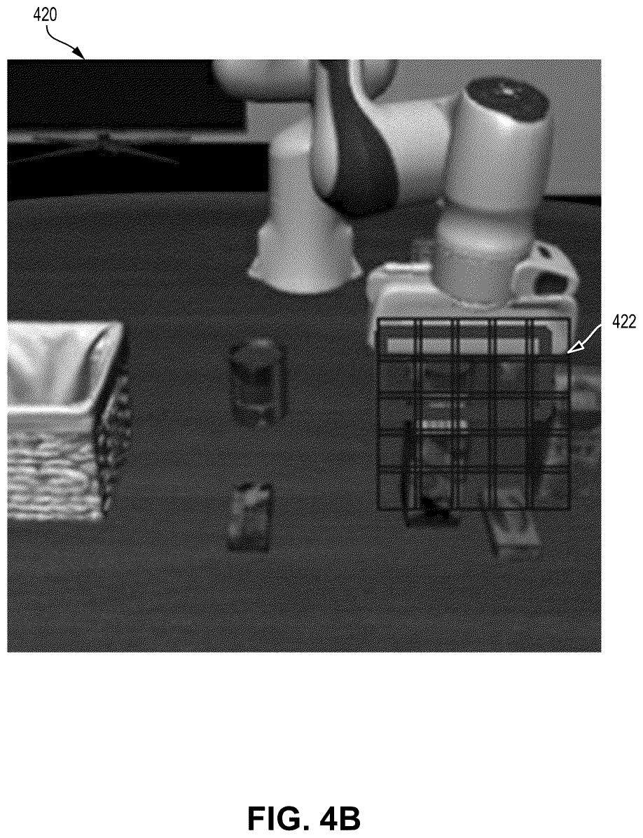

FIG. 4A is a diagram illustrating an example process 400 for generating tokens for processing in accordance with aspects of the present disclosure. Machine learning system 300 of FIG. 3A may implement process 400. Process 400 depicts operations, which represent one example of forming segmented patches 404 and patches 405 from input image 402, and generating visual tokens 406 from segmented patches 404 and patches 405. Input image 402, segmented patches 404, and patches 405 are depicted visually.

In process 400, input image 402 may be segmented into various patches (e.g., with different patches representing different objects). The segmentation of input image 402 is shown by boxes and lines surrounding each segmented area. The segmentation of input image 402 may generate segmented patches 404 and patches 405.

Referring back to FIG. 3A, these operations may be performed by object-detection model 304.

In some aspects, an object of interest may be identified in input image 402. For example, the gripper of the robot arm is detected as the object of interest. In some cases, the object of interest may be identified in input image 402 through various detection and identification techniques. For example, an object detector (or segmentation model, such as object-detection model 304) may be employed to automatically identify and locate the object of interest within the image. The object detector may utilize machine learning algorithms trained to recognize specific types of objects, such as robotic grippers, vehicle components, other vehicles, or other relevant objects depending on the application. The segmentation model may analyze the image to distinguish between objects, enabling the identification of the object of interest based on its visual characteristics, shape, or other distinguishing features.

Additionally, or alternatively, the object of interest may be tracked based on a known position of the object of interest. For instance, the object of interest may be tracked based on command and control signals provided to the object of interest, such as command and control signals provided to a robot arm that indicate the intended or actual position and orientation of the gripper. Additionally, or alternatively, sensor signals may be utilized to determine the position of the object of interest, including data from encoders, position sensors, cameras, or other sensing devices that provide real-time information about the object's location and movement. This tracking approach may be particularly useful when the object of interest is part of a controlled system where the position of controlled elements can be determined through system state information rather than relying solely on visual detection methods.

In process 400, a model identifies segmented patches 404 that correspond to the additional objects within the input image 402. The set of patches that correspond to each object are fused into a respective visual token, such that one visual token is output per object. For example, one of visual tokens 406 may be generated for each of segmented patches 404.

Further, tokens 407 are generated based on patches 405. For example, one of tokens 407 may be generated for each one of patches 405.

Finally, visual tokens 406 and tokens 407 are combined into token representation 408. Token representation 408 is output, provided to projector 410, and then the output of projector 410 is provided to LLM 412.

FIG. 4B is a diagram illustrating an example of an input image 420 with bounding boxes, in accordance with aspects of the present disclosure. Image 420 includes grid of patches 422, which represent the identified object of interest (e.g., the gripper hand) within the image 420. The grid of patches 422 is a 5×5 grid of patches. Accordingly, the object of interest and surrounding areas are represented with a total of 25 patches. As discussed with respect to FIGS. 3A and 4A, the tokens for these patches are combined with other tokens (e.g., combined visual tokens), that represent additional objects within input image 402.

In some cases, a sequence of frames (e.g., images) may be provided to system 300. For instance, video data including video frames may be provided to system 300. In the example of a moving object (e.g., a ball), system 300 can access video frames and track the object through time between frames. A machine learning model (e.g., a small model including linear layers and/or other layers) can be trained to condense the tracking information into one or more tokens that track the history of the moving object. For instance, the token can represent the object, then as the object moves from frame to frame, the patches may be repositioned.

In some aspects, object tracking may be used to provide visual tokens with temporal history information. For transformers to have a “memory,” they may be provided with their own past observations and actions. VLA models may benefit from memory capabilities, even for relatively simple tasks such as “swap the locations of these two objects” or “rotate this object by 90 degrees.” This memory may be useful because as soon as an agent picks up an object, it may not know where the object was previously located, how far along the task it has progressed, or other contextual information about the manipulation sequence.

Additionally, the history may provide information about dynamic properties of objects in the scene. For example, when catching a moving ball, the historical trajectory information may indicate the speed and direction of the ball's movement, which may be useful for predicting where the ball will be and planning appropriate catching actions.

However, patch-based visual observations may be computationally expensive when maintaining temporal history. For example, with 256 tokens per image, maintaining 8 steps of visual memory may result in 2048 tokens, leading to very large input sequences that increase computational complexity quadratically in transformer architectures.

With the object-centric approach described herein, objects may be tracked through time using recent segmentation and tracking models. As described previously, patch features for an object may be pooled into visual object tokens. The same pooling principle may be applied temporally: visual object tokens at timesteps t-n through t may be pooled into a single “object history token” to provide visual memory spanning n steps back in time.

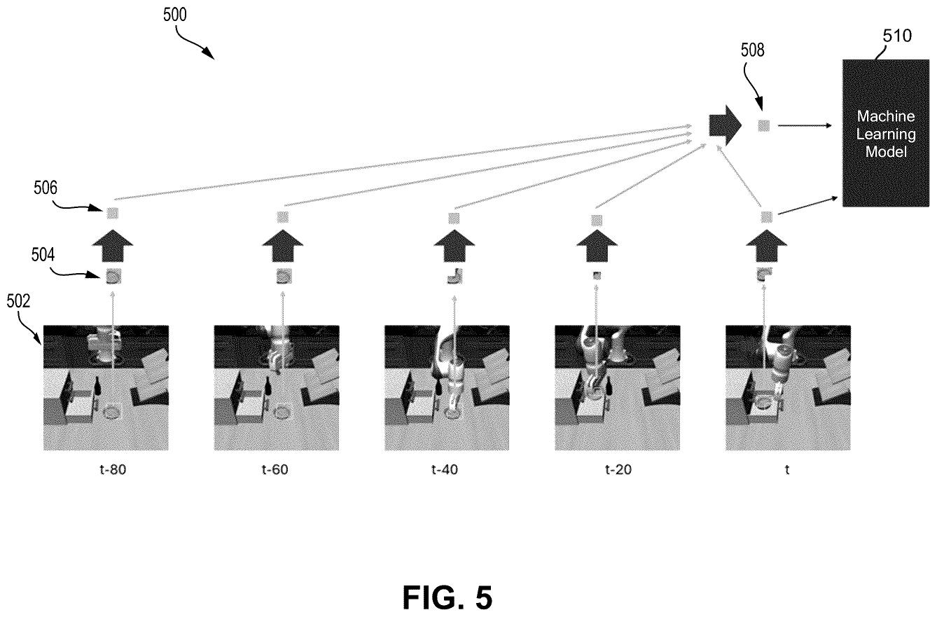

FIG. 5 is a diagram illustrating a visual depiction of various images and patches to provide context for a description of a process 500 for using an object history, according to various aspects of the present disclosure. FIG. 5 includes five example images 502 captured at five respective times. For example, images 502 include a leftmost image, captured at a time “t-80” (e.g., the current time “t” minus 80 time units, such as minus 80 milliseconds) a second-from-the-left image, captured at a time “t-60,” a middle image, captured at a time “t-40,” a second-from-the-right image, captured at a time “t-20,” and a rightmost image captured at time “t.”

Additionally, FIG. 5 includes five sets of image patches 504 corresponding to images 502. For example, sets of patches 504 include a set of patches from the leftmost image representing an object (e.g., at time t-80), a set of patches from the second-from-the-left image representing the same object (e.g., at time t-60), a set of patches from the middle image representing the same object (e.g., at time t-40), a set of patches from the second-from-the-right image representing the same object (e.g., at time t-20), and a set of patches from the rightmost image representing the same object (e.g., at time t).

All of the patches representing the object at each time may be combined (e.g., as described with regard to feature-pooling model 312) to generate tokens 506. For example, all of the patches of from the leftmost image representing the object (e.g., at time t-80) may be combined to generate a leftmost token of tokens 506. Additionally, all of the patches of from the second-from-the-left image representing the object (e.g., at time t-60) may be combined to generate a second-from-the-left token of tokens 506. Additionally, all of the patches of from the middle image representing the object (e.g., at time t-40) may be combined to generate a middle token of tokens 506. Additionally, all of the patches of from the second-from-the-right image representing the object (e.g., at time t-20) may be combined to generate a second-from-the-right token of tokens 506. Additionally, all of the patches of from the rightmost image representing the object (e.g., at time t) may be combined to generate a rightmost token of tokens 506.

According to various aspects of the present disclosure, a temporal-pooling engine may pool all of tokens 506 to generate an “object-history token”—token 508. For example, an attention transformer may be used to temporally self-attend tokens 506 to generate token 508. Additionally or alternatively, token 508 may be generated using a fully-connected neural net (e.g., a multilayer perceptron (MLP)), a one-dimensional (1D) convolution, max pooling, average pooling, and/or any learned model that can compress information.

In FIG. 5, an “additional” object is used as an example. Additionally, or alternatively, the primary object may be tracked in substantially the same way. For example, the patches 504 may be the image patches representing the object of interest. In such aspects, the pooling of features to generate a single token per object may be skipped. For example, tokens 506 may include a number of tokens, (e.g., one token for each patch of the corresponding set of patches). For instance, if the leftmost set of patches included nine patches, the leftmost tokens may include nine tokens. Further, token 508 may include a number of tokens (e.g., one for each patch of the sets of patches). For instance, each of the sets of patches included nine respective patches, token 508 may include nine patches.

In some aspects, token 508 may be provided to a machine learning model 510 (and/or to a projector, such as projector 322) as a separate token that encodes the temporal history of the object. Additionally, or alternatively, token 508 may be combined with the most recent visual token (e.g., the rightmost token of tokens 506), creating a single token that represents both the current state and the historical trajectory of the object.

This approach may significantly reduce the number of tokens required to represent temporal information while preserving important historical context for the machine learning model.

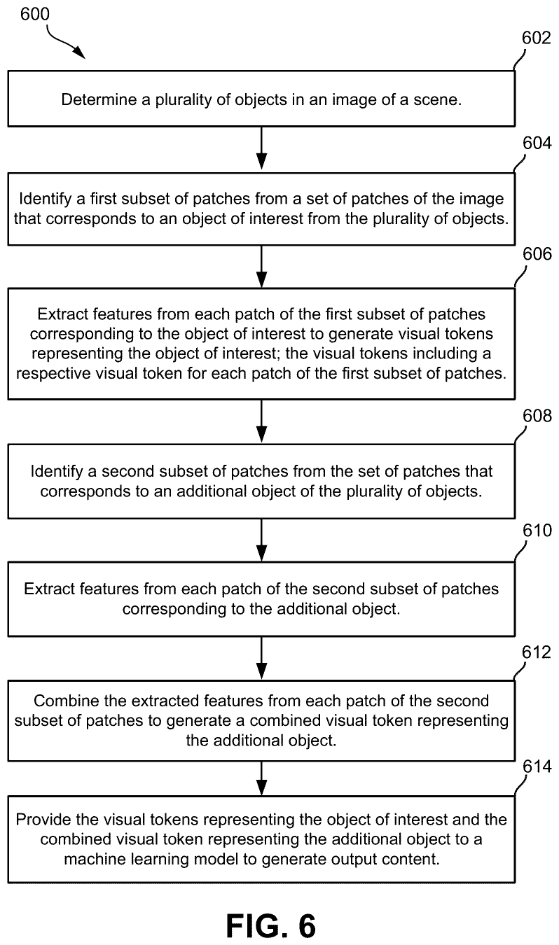

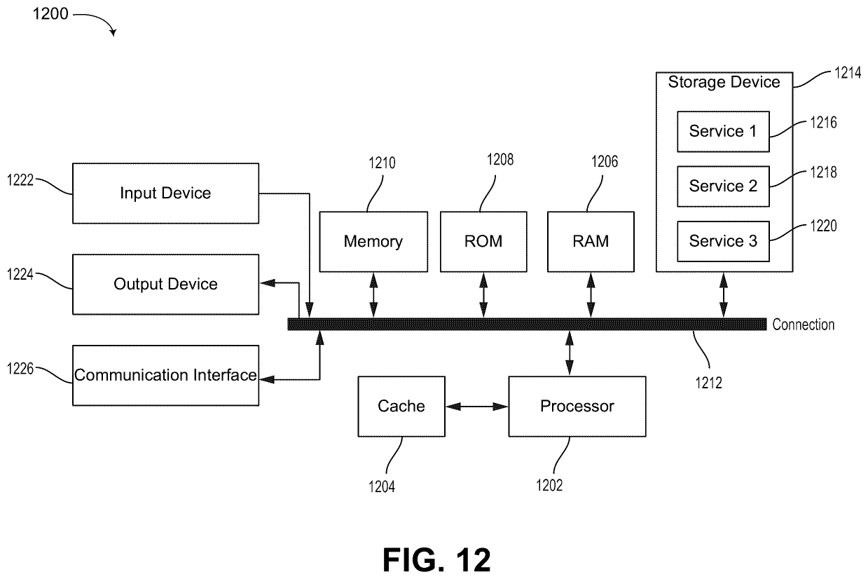

FIG. 6 is a flow diagram illustrating an example of a process 600 for machine learning, in accordance with aspects of the present disclosure. Process 600 can be performed by a computing device (e.g., SOC 100 of FIG. 1, computing device or computing-device architecture 1200 of FIG. 12, etc.) or by a component or system (e.g., the machine learning model system 200 of FIG. 2, the models depicted in FIG. 3A such as object-detection model 304, feature-extraction model 310, feature-pooling model 312, and mask applicator 315, etc.), a chipset, one or more processors central processing units (CPUs), digital signal processors (DSPs), graphics processing units (GPUs), any other type of processor(s), any combination thereof, or other component or system) of the computing device. The operations of process 600 can be implemented as software components that are executed and run on one or more processors of the computing device. Further, the transmission and reception of signals by the computing device in process 600 can be enabled, for example, by one or more antennas, one or more microphones, and/or one or more transceivers (e.g., wireless transceiver(s)).

At block 602, the computing device (or component thereof) can determine a plurality of objects in an image of a scene. For example, object-detection model 304 may detect a plurality of objects in image 302.

In some aspects, to determine the plurality of objects in the image, computing device (or one or more components thereof) may generate a plurality of masks, wherein each mask of the plurality of masks indicates pixels of the image that represent a respective object of the plurality of objects. For example, object-detection model 304 may generate additional-object masks 305 and primary-object mask 306.

In an aspect, the computing device may determine a set of patches for the image. In an aspect, the computing device may determine the set of patches for the image by providing the image to an additional machine learning model (such as DinoV2 and/or SigLIP) and receive, from the additional machine learning model, an identification of the set of patches.

In some aspects, the computing device may divide the image into a fixed set of patches, for example, an M×N grid of patches.

At block 604, the computing device (or component thereof) can identify a first subset of patches from a set of patches of the image that corresponds to one or more objects of interest from the plurality of objects. For example, object-detection model 304 may determine primary-object mask 306. Primary-object mask 306 may indicate pixels of image 302 that represent the object. Additionally or alternatively, object-detection model 304 may determine patches from among the plurality of patches that correspond to the object.

In an aspect, the computing device may determine a particular object of the plurality of objects as the object of interest. In an aspect, the computing device may determine the particular object of the plurality of objects as the object of interest based on user input indicating the particular object as the object of interest.

In some aspects, the object of interest is a main actionable object. For example, the object of interest may be a robot arm and/or hand.

In some aspects, the object of interest is configured to be controlled by the output content. For example, the output content described with regard to block 614 may control the object of interest.

In some aspects, the output content corresponds to an action executable by an external device. For example, the output content described with regard to block 614 may control the object of interest.

In some aspects, the output content comprises instructions, and wherein the instructions comprise one or more measurements of movement, angle, or grip. For example, the object of interest may be a robot arm or hand. The output content described with regard to block 614 may control movements of the robot arm and/or hand.

In some aspects, the computing device (or one or more components thereof) may determine a particular object of the plurality of objects as the object of interest. For example, object-detection model 304 may be configured to detect the object of interest.

In some aspects, the computing device (or one or more components thereof) may determine the particular object of the plurality of objects as the object of interest based on user input indicating the particular object as the object of interest. For example, a user may provide input indicating that the robot arm is the object of interest.

In some aspects, to identify the first subset of patches, the at least one processor is configured to select the first subset of patches from among the set of patches based on a position of the object of interest in the scene. For example, system 300 may have information indicating a position of the object of interest. For example, the robot arm may provide position information to system 300. System 300 may identify the object of interest in image 302 based on the position information. Additionally or alternatively, system 300 may track the object of interest based on output content (e.g., instructions) provided to the object of interest.

In some aspects, the computing device (or one or more components thereof) may determine the position of the object of interest in the scene based on at least one of sensor data or command and control data. For example, system 300 may receive sensor data (e.g., of actuators) indicating a position of the object of interest. For example, the robot arm may provide actuator position data to system 300. System 300 may identify the object of interest in image 302 based on the position information or sensor data. Additionally or alternatively, system 300 may track the object of interest based on output content (e.g., command and control data) provided to the object of interest.

At block 606, the computing device (or component thereof) can extract features from each patch of the first subset of patches corresponding to the object(s) of interest to generate visual tokens representing the object of interest. The visual tokens include a respective visual token for each patch of the first subset of patches. For example, feature-extraction model 310 may generate feature tokens 311 based on image 302. In some aspects, feature-extraction model 310 may generate a token for each patch of the image that represents the object. In other aspects, feature-extraction model 310 may generate feature tokens 311 representing the whole of image 302 and mask applicator 315 may select tokens of feature tokens 311 that correspond to primary-object mask 306.

In some aspects, to extract the features from each patch of the first subset of patches, the computing device (or one or more components thereof) may process each patch of the first subset of patches using an image-encoder machine-learning model, wherein the image-encoder machine-learning model is configured to generate image features based on images. For example, feature-extraction model 310 may process image 302. Additionally or alternatively, feature-extraction model 310 may process each patch of image 302 that includes the primary object (e.g., based on primary-object mask 306).

In some aspects, to extract the features from each patch of the first subset of patches, the computing device (or one or more components thereof) may process each patch of the first subset of patches using two or more image-encoder machine-learning models, wherein each image-encoder machine-learning model of the two or more image-encoder machine-learning models is configured to generate image features based on images. For example, feature-extraction model 310 (which may include two or more image-encoder machine-learning models) may process image 302. Additionally or alternatively, feature-extraction model 310 (which may include two or more image-encoder machine-learning models) may process each patch of image 302 that includes the primary object (e.g., based on primary-object mask 306).

At block 608, the computing device (or component thereof) can identify a second subset of patches from the set of patches that corresponds to an additional object of the plurality of objects. For example, object-detection model 304 may generate additional-object masks 305 that may represent one or more additional objects.

At block 610, the computing device (or component thereof) can extract features from each patch of the second subset of patches corresponding to the additional object.

For example, feature-pooling model 312 may identify features that represent the additional object. In some aspects, feature-extraction model 310 may generate a token for each patch that represents the additional object. In other aspects, feature-extraction model 310 may generate feature tokens 311 representing the whole of image 302 and feature-pooling model 312 may select tokens of feature tokens 311 that correspond to additional-object masks 305.

At block 612, the computing device (or component thereof) can combine the extracted features from each patch of the second subset of patches to generate a combined visual token representing the additional object. For example, feature-pooling model 312 may combine the features representing the additional object to generate combined visual tokens 316.

In some aspects, to combine the extracted features from each patch of the second subset of patches, the computing device (or one or more components thereof) may determine an average value for the extracted features. For example, feature-pooling model 312 may determine an average value to determine combined visual tokens 316.

In some aspects, to combine the extracted features from each patch of the second subset of patches, the computing device (or one or more components thereof) may use at least one of max-pooling, average-pooling, attention pooling, or a transformer model on the extracted features. For example, feature-pooling model 312 may use max-pooling, average-pooling, attention pooling, and/or a transformer model on feature tokens 311 to generate combined visual tokens 316.

At block 614, the computing device (or component thereof) can provide the visual tokens representing the object of interest and the combined visual token representing the additional object to a machine learning model to generate output content. For example, system 300 may provide combined visual tokens 316 and visual tokens 318 to large language model 326 and large language model 326 may generate discrete actions 328 based on combined visual tokens 316 and visual tokens 318.

In some aspects, the computing device (or one or more components thereof) may adjust the visual tokens representing the object of interest and the combined visual token representing the additional object to be suitable for the machine learning model. For example, projector 322 may project token representation 320 into a format suitable for large language model 326.

In some aspects, the computing device (or one or more components thereof) may project the visual tokens representing the object of interest and the combined visual token representing the additional object from an image-embedding space to a text-embedding space. For example, projector 322 may project token representation 320 into a text-embedding space.

In some aspects, the computing device (or one or more components thereof) may identify a plurality of subsets of patches from the set of patches, wherein each subset of patches of the plurality of subsets of patches comprises a respective number of patches, and wherein each subset of patches of the plurality of subsets of patches corresponds to a respective object of the plurality of objects; extract respective features from each patch of each subset of patches of the plurality of subsets of patches; combine the respective extracted features from each subset of patches of the plurality of subsets of patches to generate a plurality of sets of combined visual tokens, wherein each set of combined visual tokens corresponds to one of the plurality of subsets of patches; and provide the plurality of sets of combined visual tokens to the machine learning model to generate output content. For example, additional-object masks 305 may generate a plurality of masks (e.g., primary-object mask 306) representing a plurality of objects. Feature-pooling model 312 may identify a plurality of sets of patches of image 302 that represent the plurality of objects. Feature-pooling model 312 may identify respective sets of features that represent each of the additional objects. In some aspects, feature-extraction model 310 may generate a token for each patch that represents each of the additional objects. In other aspects, feature-extraction model 310 may generate feature tokens 311 representing the whole of image 302 and feature-pooling model 312 may select tokens of feature tokens 311 that correspond to additional-object masks 305. Feature-pooling model 312 may combine the features representing the each of the additional objects to generate a respective sets of combined visual tokens 316. In an aspect, to combine the extracted features from each patch of the second subset of patches, the computing device may determine an average value for the extracted features. In an aspect, to combine the extracted features from each patch of the second subset of patches, the computing device may use max-pooling, average-pooling, attention pooling, a transformer model, and/or other operations or models on the extracted features. For instance, the extracted features may be combined using a machine learning model such as a transformer model. System 300 may provide the sets of combined visual tokens 316 and visual tokens 318 to large language model 326 and large language model 326 may generate discrete actions 328 based on combined visual tokens 316 and visual tokens 318.

In some aspects, the plurality of subsets of patches comprises a predetermined count of subsets of patches. For example, object-detection model 304 may identify a predetermined number of objects in image 302 and feature-pooling model 312 may generate respective sets of combined visual tokens 316 based on the detected objects.

In an aspect, the output content corresponds to an action executable by an external device. In an aspect, the output content comprises instructions, and wherein the instructions comprise one or more measurements of movement, angle, or grip.

In some aspects, the machine learning model may be, or may include, a large language model. For example, large language model 326 may be, or may include, a large language model.

In some aspects, the computing device (or one or more components thereof) may provide text tokens based on instructions to the large language model. The large language model may be configured to generate the output content based on the visual tokens representing the object of interest, the combined visual token representing the additional object, and the text tokens. For example, system 300 may provide language tokens 324 and token representation 320 (or an output of projector 322, for example, projected token representation 320) to large language model 326 and large language model 326 may be configured to generate discrete actions 328 based on language tokens 324, and token representation 320 (or token representation 320 as projected by projector 322).

In some aspects, the output content comprises a control signal for controlling operation of a component. For example, discrete actions 328 may be, or may include, a control signal for controlling operation of a component, such as a robot arm and/or hand.

In some aspects, component comprises at least one of: an actuator, a solenoid, a motor, a valve, or an electromagnet. For example, discrete actions 328 may be, or may include, a control signal from an actuator, a solenoid, a motor, a valve, and/or an electromagnet.

In some aspects, the computing device (or one or more components thereof) may identify a plurality of subsets of patches based on a plurality of images of the object of interest, wherein each subset of patches corresponds to a respective image of the plurality of images, wherein the plurality of subsets of patches corresponds to the object of interest; extract features from the plurality of subsets of patches to generate a plurality of visual tokens representing the object of interest, wherein each subset of patches corresponds to a respective visual token of the plurality of visual tokens; combine the plurality of visual tokens to generate a combined visual token representing the object of interest; and provide the combined visual token representing the object of interest to the machine learning model to generate the output content.

For example, System 300 may obtain a number of instances of image 302.

Feature-extraction model 310 may extract respective instances of feature tokens 311 from each instance of image 302. System 300 may identify respective instances of feature tokens 311 from each of the instances of feature tokens 311 that represent the object of interest. For example, Object-detection model 304 may generate instances of primary-object mask 306 corresponding to each instance of image 302 and mask applicator 315 may apply the instances of primary-object mask 306 to the instances of feature tokens 311 to identify features the represent the object of interest. Further, system 300 may combine the features that represent the object. The combined features representing the object may then be used (e.g., by large language model 326, for example, after being projected) to generate discrete actions 328. As another example, system 300 may obtain images 502. Object-detection model 304 may identify five sets of image patches 504 that represent the object of interest. Feature-extraction model 310 may generate Tokens 506 based on the identified patches. Tokens 506 may be combined to generate token 508 and machine learning model 510 may process token 508 to generate output content.

In some aspects, the computing device (or one or more components thereof) may identify a plurality of subsets of patches based on a plurality of images of the additional object, wherein each subset of patches corresponds to a respective image of the plurality of images, wherein the plurality of subsets of patches corresponds to the additional object; extract features from the plurality of subsets of patches to generate a plurality of visual tokens representing the additional object, wherein each subset of patches corresponds to a respective visual token of the plurality of visual tokens; combine the extracted features from plurality of subsets of patches to generate a second combined visual token representing the additional object; and provide the second combined visual token representing the additional object to the machine learning model to generate the output content. For example, System 300 may obtain a number of instances of image 302.

Feature-extraction model 310 may extract respective instances of feature tokens 311 from each instance of image 302. System 300 may identify respective sets of feature tokens 311 that represent one or more additional objects. For example, Object-detection model 304 may generate instances of additional-object masks 305 corresponding to each instance of image 302 and feature-pooling model 312 may apply the instances of additional-object masks 305 to the instances of feature tokens 311 to identify sets of features the represent the one or more additional objects. Further, feature-pooling model 312 may combine the sets of features that represent the one or more additional objects. The combined sets of features representing the one or more additional objects may then be used (e.g., by large language model 326, for example, after being projected) to generate discrete actions 328. As another example, system 300 may obtain images 502. Object-detection model 304 may identify sets of five sets of image patches 504 that represent the respective additional objects. Feature-extraction model 310 may generate tokens 506 based on the identified patches. The sets of tokens 506 may be combined to generate respective instances of token 508 and machine learning model 510 may process the respective instances of token 508 to generate output content.

In an aspect, the computing device may segment of the image to determine the plurality of objects in the scene. In an aspect, to perform the segmentation of the image, the computing device may provide the image to a segmentation model and receive, from the segmentation model, a respective segmentation of each object of the plurality of objects in the image.

In some examples, the computing device (or component thereof) can fine-tune parameters of the first machine learning model using a loss function based on a comparison of the instructions associated with performance of the sub-task and expected instructions associated with performance of the sub-task.

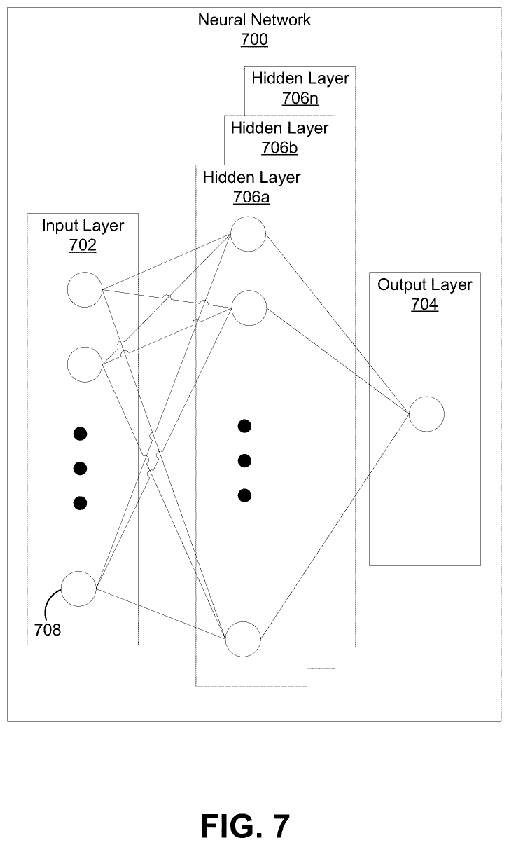

FIG. 7 is a diagram illustrating an illustrative example of a deep learning neural network 700 that can be used by the machine learning model 206, the task engine 212, the image-processing engine 207, and the image-processing engine 207. An input layer 720 includes input data. In one illustrative example, the input layer 720 can include data representing the pixels of an input image or video frame. The neural network 700 includes multiple hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. The neural network 700 further includes an output layer 724 that provides an output resulting from the processing performed by the hidden layers 722a, 722b, through 722n. In one illustrative example, the output layer 724 can provide a classification for an object in an input image or video frame. The classification can include a class identifying the type of object (e.g., a static object, a vehicle, a person, a dog, a cat, or other object).

The neural network 700 is a multi-layer neural network of interconnected nodes. Each node can represent a piece of information. Information associated with the nodes is shared among the different layers and each layer retains information as information is processed. In some cases, the neural network 700 can include a feed-forward network, in which case there are no feedback connections where outputs of the network are fed back into itself. In some cases, the neural network 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the hidden layers 722a, 722b, through 722n can transform the information of each input node by applying activation functions to the information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 724, at which an output is provided. In some cases, while nodes (e.g., node 726) in the neural network 700 are shown as having multiple output lines, a node has a single output and all lines shown as being output from a node represent the same output value.

In some cases, each node or interconnection between nodes can have a weight that is a set of parameters derived from the training of the neural network 700. Once the neural network 700 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

The neural network 700 is pre-trained to process the features from the data in the input layer 720 using the different hidden layers 722a, 722b, through 722n in order to provide the output through the output layer 724. In an example in which the neural network 700 is used to identify objects in images, the neural network 700 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 700 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 700 is trained well enough so that the weights of the layers are accurately tuned.

In the example of identifying objects in images, the forward pass can include passing a training image through the neural network 700. The weights are initially randomized before the neural network 700 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 700, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 700 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 700 can perform a backward pass by determining which inputs (weights) most contributed to the loss of the network and can adjust the weights so that the loss decreases and is eventually minimized.

A derivative of the loss with respect to the weights (denoted as dL/dfW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and f denotes a learning rate. The learning rate can be set to any suitable value, with a high learning rate including larger weight updates and a lower value indicating smaller weight updates.

The neural network 700 can include any suitable deep network. One example includes a convolutional neural network (CNN), which includes an input layer and an output layer, with multiple hidden layers between the input and out layers. An example of a CNN is described below with respect to FIG. 7. The hidden layers of a CNN include a series of convolutional, nonlinear, pooling (for downsampling), and fully connected layers. The neural network 700 can include any other deep network other than a CNN, such as an autoencoder, a deep belief nets (DBNs), and a Recurrent Neural Networks (RNNs), among others.

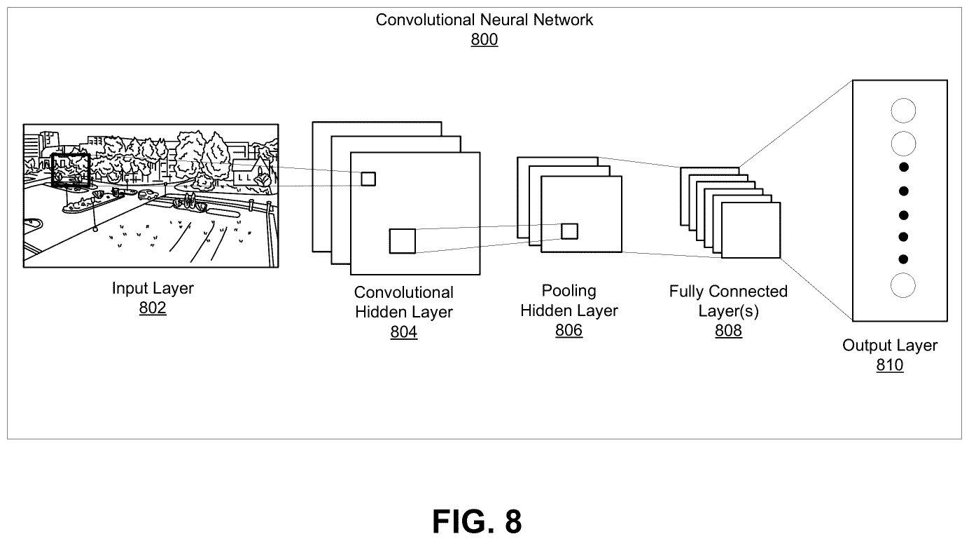

FIG. 8 is a diagram illustrating an illustrative example of a convolutional neural network 800 (CNN 800). The input layer 820 of the CNN 800 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 822a, an optional non-linear activation layer, a pooling hidden layer 822b, and fully connected hidden layers 822c to get an output at the output layer 824. While only one of each hidden layer is shown in FIG. 8, one of ordinary skill will appreciate that multiple convolutional hidden layers, non-linear layers, pooling hidden layers, and/or fully connected layers can be included in the CNN 800. As previously described, the output can indicate a single class of an object or can include a probability of classes that best describe the object in the image.

The first layer of the CNN 800 is the convolutional hidden layer 822a. The convolutional hidden layer 822a analyzes the image data of the input layer 820. Each node of the convolutional hidden layer 822a is connected to a region of nodes (pixels) of the input image called a receptive field. The convolutional hidden layer 822a can be considered as one or more filters (each filter corresponding to a different activation or feature map), with each convolutional iteration of a filter being a node or neuron of the convolutional hidden layer 822a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 822a. Each connection between a node and a receptive field for that node learns a weight and, in some cases, an overall bias such that each node learns to analyze its particular local receptive field in the input image. Each node of the hidden layer 822a will have the same weights and bias (called a shared weight and a shared bias). For example, the filter has an array of weights (numbers) and the same depth as the input. A filter will have a depth of 3 for the image or video frame example (according to three color components of the input image). An illustrative example size of the filter array is 5×5×3, corresponding to a size of the receptive field of a node.

The convolutional nature of the convolutional hidden layer 822a is due to each node of the convolutional layer being applied to its corresponding receptive field. For example, a filter of the convolutional hidden layer 822a can begin in the top-left corner of the input image array and can convolve around the input image. As noted above, each convolutional iteration of the filter can be considered a node or neuron of the convolutional hidden layer 822a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 822a. For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 822a.

The mapping from the input layer to the convolutional hidden layer 822a is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 822a can include several activation maps in order to identify multiple features in an image. The example shown in FIG. 8 includes three activation maps. Using three activation maps, the convolutional hidden layer 822a can detect three different kinds of features, with each feature being detectable across the entire image.

In some examples, a non-linear hidden layer can be applied after the convolutional hidden layer 822a. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 800 without affecting the receptive fields of the convolutional hidden layer 822a.

The pooling hidden layer 822b can be applied after the convolutional hidden layer 822a (and after the non-linear hidden layer when used). The pooling hidden layer 822b is used to simplify the information in the output from the convolutional hidden layer 822a. For example, the pooling hidden layer 822b can take each activation map output from the convolutional hidden layer 822a and generates a condensed activation map (or feature map) using a pooling function. Max-pooling is one example of a function performed by a pooling hidden layer. Other forms of pooling functions be used by the pooling hidden layer 822a, such as average pooling, L2-norm pooling, or other suitable pooling functions. A pooling function (e.g., a max-pooling filter, an L2-norm filter, or other suitable pooling filter) is applied to each activation map included in the convolutional hidden layer 822a. In the example shown in FIG. 8, three pooling filters are used for the three activation maps in the convolutional hidden layer 822a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 822a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 822a having a dimension of 24×24 nodes, the output from the pooling hidden layer 822b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

Intuitively, the pooling function (e.g., max-pooling, L2-norm pooling, or other pooling function) determines whether a given feature is found anywhere in a region of the image and discards the exact positional information. The positional information can be discarded without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 800.

The final layer of connections in the network is a fully-connected layer that connects every node from the pooling hidden layer 822b to every one of the output nodes in the output layer 824. Using the example above, the input layer includes 28×28 nodes encoding the pixel intensities of the input image, the convolutional hidden layer 822a includes 3×24×24 hidden feature nodes based on application of a 5×5 local receptive field (for the filters) to three activation maps, and the pooling layer 822b includes a layer of 3×12×12 hidden feature nodes based on application of max-pooling filter to 2×2 regions across each of the three feature maps. Extending such an example, the output layer 824 can include ten output nodes. In such an example, every node of the 3×12×12 pooling hidden layer 822b is connected to every node of the output layer 824.

The fully connected layer 822c can obtain the output of the previous pooling layer 822b (which should represent the activation maps of high-level features) and determines the features that most correlate to a particular class. For example, the fully connected layer 822c layer can determine the high-level features that most strongly correlate to a particular class and can include weights (nodes) for the high-level features. A product can be computed between the weights of the fully connected layer 822c and the pooling hidden layer 822b to obtain probabilities for the different classes. For example, if the CNN 800 is being used to predict that an object in an image or video frame is a vehicle, high values will be present in the activation maps that represent high-level features of vehicles (e.g., two or four tires, a windshield, side view mirrors, etc.).

In some examples, the output from the output layer 824 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.8 0 0 0 0], the vector indicates that there is a 5% probability that the image is the third class of object (e.g., a person), an 80% probability that the image is the fourth class of object (e.g., a static object on a road or other driving surface), and a 8% probability that the image is the sixth class of object (e.g., a vehicle). The probability for a class can be considered a confidence level that the object is part of that class.

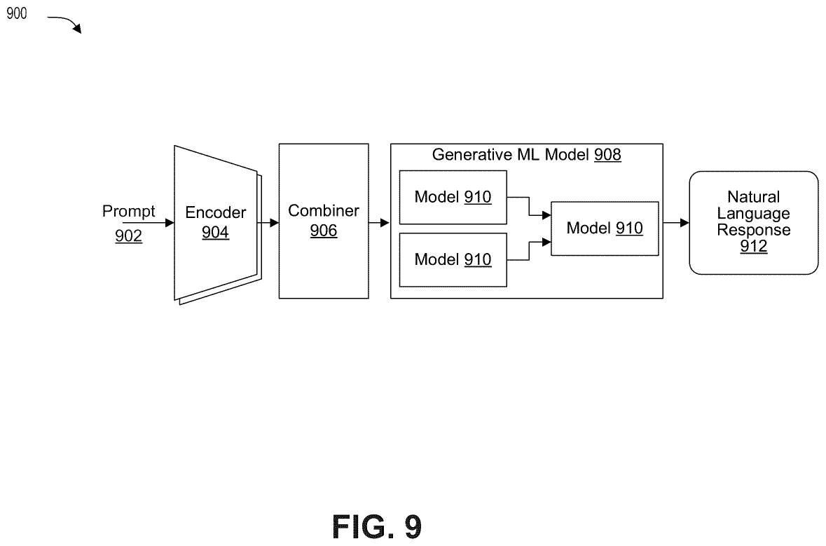

FIG. 9 is a block diagram illustrating a multimodal generative machine-learning (ML) system 900 for generating natural language responses based on natural language input from a prompt 902 and any additional information. A multimodal machine learning system is a machine learning model that receives, processes, and outputs data in multiple forms. For example, the input prompt may include text, images, and audio. Machine learning model 206 of FIG. 2, large language model 326 of FIG. 3A, LLM 412 of FIG. 4A, and/or machine learning model 510 of FIG. 5 may be examples of multimodal generative ML system 900.

For example, the multimodal generative ML system 900 includes a plurality of encoders 904 that are each configured to encode different modes of content (e.g., text, images, audio, etc.) into different tokens within a common embedding space. For example, a text input may be segmented based on different techniques (e.g., paragraph, sentence, etc.) and encoded by a text encoder (from the encoders 904) into tokens. In another example, one or more images can be provided to an image encoder (from the encoders 904) that extracts features associated with the image and generates tokens representing the visual features. In another example, audio can be provided to an audio encoder (from the encoders 904) that extracts features associated with the image and generates tokens representing the audio features. In the case of audio, the audio encoder can identify features that can include formants that characterize resonant frequencies in speech, rhythmic features related to timing and tempo, and harmonic features that describe the relationship between fundamental frequencies and their harmonics.

The different tokens from the plurality of encoders are provided to combiner 906. The combiner 906 can combine the tokens based on the order in which they are presented. For example, the input into the encoder may be an array of primitive values. A primitive value is an immutable data type provided by a programming language and includes values that represent a single piece of data (e.g., number, string, Boolean, etc.) rather than a complex object or reference. A non-limiting example prompt may include a byte array (e.g., an unsigned 8-byte integer array or uint8array), and another string. The byte array may be audio, images, or other content that can be processed by the encoders 904. In some aspects, the combiner 906 is configured to concatenate the different tokens in order based on the array to preserve the semantic order of features and provide the tokens to the generative machine learning model 908.

The generative machine learning model 908 is configured to receive the tokens and generate a natural language response 912 based on the tokens and the prompt 902. Generative machine learning model 908 may include one or more models 910 (e.g., transformer neural network(s), diffusion model(s), fully connected layer(s), multilayer perceptrons (MLPs), any combination thereof, and/or other models). The one or more models 910 of the generative machine learning model 908 are configured to process the tokens and extract different types of features that are relevant to the prompt 902. For example, the prompt 902 can be a query for a particular type of information. The one or more models of the generative machine learning model 908 can perform different tasks related to the query, such as writing code to perform a particular function, generating an image based on an input image with expressed modifications, generating an image without any input image, and so forth.

The generative machine learning model 908 may include different components, such as a featurization engine to identify different types of features, an inference engine to identify inferences within the text (e.g., pronoun usage and corresponding disambiguation functions), data retrieval engines (e.g., to identify features related to a particular concept observed by the generative machine learning model 908), and so forth. The generative machine learning model 908 may also include different types of models and engines to synthesize a coherent contextual output, such as to synthesize the input content and information that is responsive to tasks embedded within the text. For example, the generative machine learning model 908 may include a predictive output engine (not shown) that is configured to generate a sequence of words that is most likely contextually correct and to provide a coherent and contextually relevant answer. For instance, the predictive output generation engine can generate responses by sampling from the probability distribution of possible words and sequences based on patterns observed during training. The generative machine learning model 908 may also include a predictive output generation engine to generate multiple responses that are potentially relevant and coherent with respect to the prompt 902. The generative machine learning model 908 may also include an output validation engine configured to evaluate the generated responses based on certain criteria. Non-limiting examples of criteria to evaluate generated responses include relevance to the prompt, coherence, fluency, and adherence to specific guidelines or rules. Based on the evaluation, the output validation engine may select and output the most appropriate response.

As noted above, the generative machine learning model 908 may include various types of models (e.g., machine learning models), such as a transformer. A transformer is a neural network architecture that can be trained to perform one or more natural language processing (NLP) tasks, such as language translation, sentiment analysis, and text summarization. Conventional traditional recurrent neural networks (RNNs) process data in sequence. A transformer or transformer network can process input in parallel and can thus be faster and more efficient than sequential training and processing. In some aspects, a transformer can use a self-attention mechanism (e.g., one or more self-attention layers), which allows the transformer to identify the most relevant parts of the input text or content (e.g., audio or video). In some cases, a transformer can also use a cross-attention mechanism (e.g., one or more cross-attention layers) which uses other content or data to determine the most relevant parts of the input. For example, cross-attention mechanisms are useful in sequential content such as a stream of data, such as optical flow, and other computer vision techniques.

A transformer neural network can include a multi-layer encoder-decoder architecture. For instance, an encoder of the encoder-decoder architecture can receive text as input, convert the input text into a sequence of hidden representations, and capture the meaning of the text at different levels of abstraction. A decoder of the encoder-decoder architecture can then process the representations output from the decoder to generate an output sequence, such as a text translation or a summary. The encoder and decoder can be trained together using supervised learning, unsupervised learning, or a combination of supervised and unsupervised learning techniques, such as maximum likelihood estimation and self-supervised pretraining. Illustrative examples of transformer engines include a BERT model, a Text-to-Text Transfer Transformer (T5), biomedical BERT (BioBERT), scientific BERT (SciBERT), and the SPECTER model for document-level representation learning. In some aspects, multiple transformer engines may be used to generate different tokens.

In some aspects, the generative machine learning model 908 may be executed using a neural engine (or multiple neural engines) for on-device execution, such as a neural processing unit (NPU), a neural signal processor (NSP), a digital signal processor (DSP), any combination thereof, and/or other neural engine. The neural engine can include a plurality of neural processing cores that are configured to parallelize operations associated with neural networks. A neural processing core can include arrays of multiply-accumulate (MAC) units and specialized instructions that are optimized for matrix operations, such as convolution and matrix multiplication. The neural processing core can receive input data and perform matrix transformations and nonlinear activation functions to break down and parallelize matrix operations. The neural processing core can perform tasks such as inference (e.g., runtime operation of a machine learning model) or training of deep learning models. The neural processing core can accelerate tasks by parallelization of larger computations that can be performed in parallel (e.g., matrix operations associated with neural networks). For instance, the neural engine may perform computer vision tasks such as object recognition. In some cases, the neural engine can be implemented based on various ML libraries such as PyTorch, which interfaces with the compute unified device architecture (CUDA) to parallelize operations.

In some aspects, the generative machine learning model 908 may be a small generative model that has fewer parameters, fewer layers, fewer neurons, or a simpler architecture compared to larger models. A small generative model may not capture the full complexity of the underlying data distribution as effectively as larger models but can still be useful in scenarios where computational resources are limited or where a simpler model is sufficient for the task. Small generative models can also be easier to train and interpret, making them suitable for certain applications. For example, ChatGPT-3.5 has 175 billion parameters that results in a size of 1.4 Terabytes (TB) for a model implemented with double-precision floating point numbers. A smaller model may have a simpler architecture, use fewer parameters (e.g., 10 million), and use less precise numbers (e.g., single-precision floating point numbers) resulting in a size of 38 Megabytes (MB).

In addition, small models benefit from increased training based on local execution and data specific to a local device and a user of that local device. An additional benefit to small models is increased privacy because the information is not transmitted over the network and only relies on information requested by the user or usage at the local device.

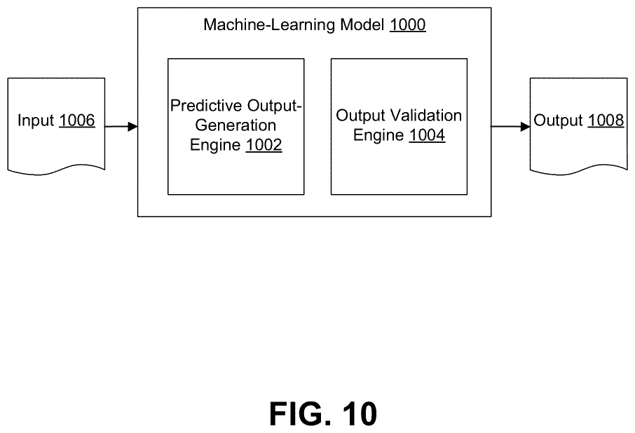

FIG. 10 includes an example machine-learning model 1000 that may be used in various aspects of the present disclosure. For example, machine learning model 206 of FIG. 2, large language model 326 of FIG. 3A, LLM 412 of FIG. 4A, and/or machine learning model 510 of FIG. 5 may be examples of machine-learning model 1000.

Machine-learning model 1000 is an example of a generative response engine. Generative response engines are commonly referred to as Generative AI. Generative response engines can receive an input prompt (e.g., input 1006) and generate content (e.g., output 1008) based on the prompt. Generative Pre-trained Transformers (GPTs), diffusion models, and diffusion-transformer models are some non-limiting examples of generative response engines.

Machine-learning model 1000 includes a predictive output-generation engine 1002 and Output validation engine 1004. Predictive output-generation engine 1002 may analyze input 1006 and identify relevant patterns and associations based on data on which predictive output-generation engine 1002 was trained. Further, predictive output-generation engine 1002 may predict a sequence of words that are the most likely continuation of input 1006. By iteratively predicting next words, predictive output-generation engine 1002 may aim to provide a coherent and contextually relevant answer to input 1006. Predictive output-generation engine 1002 may generate responses by sampling from the probability distribution of possible words and sequences, guided by the patterns observed during the training of predictive output-generation engine 1002. In some aspects, predictive output-generation engine 1002 may generate multiple possible responses before outputting a final one. The multiple responses may be variations that predictive output-generation engine 1002 considers potentially relevant and coherent. Output validation engine 1004 may evaluate the multiple generated responses based on certain criteria. These criteria can include relevance to the prompt, coherence, fluency, and sometimes adherence to specific guidelines or rules, depending on the application. Based on this evaluation, output validation engine 1004 may select a most appropriate response. This selection is typically the one that scores highest on the set criteria, balancing factors like relevance, informativeness, and coherence.

Input 1006 and/or output 1008 may be, or may include, text, image data, video data, numerical data, etc. For example, machine-learning model 1000 may perform tasks such as, text summarization, text translation, text generation, responding to queries, image description, video description, image generation (e.g., based on text and/or image data), video generation (e.g., based on text and/or image data), image rendering (e.g., based on a 3D model and/or image data), object detection (e.g., based on image data and/or video data) etc. As such, machine-learning model 1000 may be referred to as a large language model (LLM), a vision-language model (VLM), a multilingual language model (MLLM) a large vision model (LVM), etc.

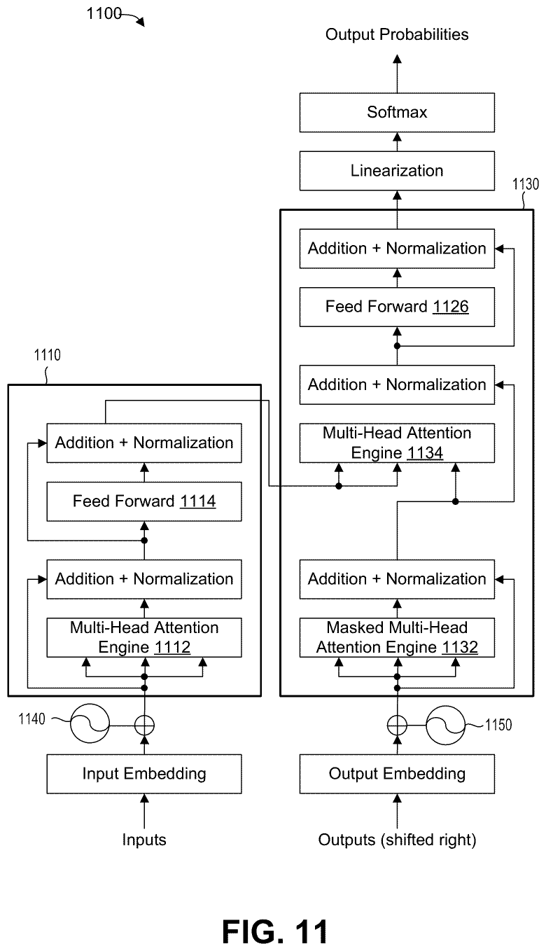

FIG. 11 is a block diagram of an example transformer 1100 in accordance with some aspects of the disclosure. Transformer 1100 may be included in multimodal generative ML system 900 and/or machine-learning model 1000.

In a convolutional neural network (CNN) model, the number of operations required to relate signals from two arbitrary input or output positions grows in the distance between positions, which makes learning dependencies at different distant positions challenging for a CNN model. A transformer 1100 reduces the operations of learning dependencies by using an encoder 1110 and a decoder 1130 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1110 is composed of a stack of six identical layers and each layer has two sub-layers. The first sub-layer is a multi-head self-attention engine 1112, and the second sub-layer is a fully-connected feed-forward network 1114. A residual connection (not shown) connects around each of the sub-layers followed by normalization.

In this example transformer 1100, the decoder 1130 is also composed of a stack of six 6 identical layers. The decoder also includes a masked multi-head self-attention engine 1132, a multi-head attention engine 1134 over the output of the encoder 1110, and a fully-connected feed-forward network 1126. Each layer includes a residual connection (not shown) around the layer, which is followed by layer normalization. The masked multi-head self-attention engine 1132 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1140 to encode positions because the model does not contain recurrence and convolution and relative or absolute position of the tokens is needed. In the transformer 1100, the positional encodings are added to the input embeddings at the bottom layer of the encoder 1110 and the decoder 1130. The positional encodings are summed with the embeddings because the positional encodings and embeddings have the same dimensions. A corresponding position decoder 1150 is configured to decode the positions of the embeddings for the decoder 1130.

In some aspects, the transformer 1100 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1100 can process input sequences of variable length, making it well-suited for natural language processing tasks where input lengths can vary greatly. Additionally, the self-attention mechanism allows the transformer 1100 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 12 illustrates an example computing-device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1200 may include, implement, or be included in any or all of SOC 100 of FIG. 1, machine learning model system 200 of FIG. 2, system 300 of FIG. 3A, and/or other devices, modules, or systems described herein. Additionally, or alternatively, computing-device architecture 1200 may be configured to perform process 400 of FIG. 4A, process 500 of FIG. 5, process 600 of FIG. 6, and/or other process described herein.

The components of computing-device architecture 1200 are shown in electrical communication with each other using connection 1212, such as a bus. The example computing-device architecture 1200 includes a processing unit (CPU or processor) 1202 and computing device connection 1212 that couples various computing device components including computing device memory 1210, such as read only memory (ROM) 1208 and random-access memory (RAM) 1206, to processor 1202.

Computing-device architecture 1200 can include a cache of high-speed memory connected directly with, in close proximity to, or integrated as part of processor 1202. Computing-device architecture 1200 can copy data from memory 1210 and/or the storage device 1214 to cache 1204 for quick access by processor 1202. In this way, the cache can provide a performance boost that avoids processor 1202 delays while waiting for data.

These and other modules can control or be configured to control processor 1202 to perform various actions. Other computing device memory 1210 may be available for use as well. Memory 1210 can include multiple different types of memory with different performance characteristics. Processor 1202 can include any general-purpose processor and a hardware or software service, such as service 1 1216, service 2 1218, and service 3 1220 stored in storage device 1214, configured to control processor 1202 as well as a special-purpose processor where software instructions are incorporated into the processor design. Processor 1202 may be a self-contained system, containing multiple cores or processors, a bus, memory controller, cache, etc. A multi-core processor may be symmetric or asymmetric.

To enable user interaction with the computing-device architecture 1200, input device 1222 can represent any number of input mechanisms, such as a microphone for speech, a touch-sensitive screen for gesture or graphical input, keyboard, mouse, motion input, speech and so forth. Output device 1224 can also be one or more of a number of output mechanisms known to those of skill in the art, such as a display, projector, television, speaker device, etc. In some instances, multimodal computing devices can enable a user to provide multiple types of input to communicate with computing-device architecture 1200. Communication interface 1226 can generally govern and manage the user input and computing device output. There is no restriction on operating on any particular hardware arrangement and therefore the basic features here may easily be substituted for improved hardware or firmware arrangements as they are developed.

Storage device 1214 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1206, read only memory (ROM) 1208, and hybrids thereof. Storage device 1214 can include services 1216, 1218, and 1220 for controlling processor 1202. Other hardware or software modules are contemplated. Storage device 1214 can be connected to the computing device connection 1212. In one aspect, a hardware module that performs a particular function can include the software component stored in a computer-readable medium in connection with the necessary hardware components, such as processor 1202, connection 1212, output device 1224, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors.

When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“<”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices.

Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure.

A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

Illustrative aspects of the disclosure include:

Aspect 1. An apparatus for generating content, the apparatus comprising: at least one memory; and at least one processor coupled to the at least one memory and configured to: determine a plurality of objects in an image of a scene; identify a first subset of patches from a set of patches of the image that corresponds to an object of interest from the plurality of objects; extract features from each patch of the first subset of patches corresponding to the object of interest to generate visual tokens representing the object of interest, wherein the visual tokens include a respective visual token for each patch of the first subset of patches; identify a second subset of patches from the set of patches that corresponds to an additional object of the plurality of objects; extract features from each patch of the second subset of patches corresponding to the additional object; combine the extracted features from each patch of the second subset of patches to generate a combined visual token representing the additional object; and provide the visual tokens representing the object of interest and the combined visual token representing the additional object to a machine learning model to generate output content.

Aspect 2. The apparatus of aspect 1, wherein the at least one processor is configured to perform segmentation of the image to determine the plurality of objects in the scene.

Aspect 3. The apparatus of aspect 2, wherein, to perform the segmentation of the image, the at least one processor is configured to provide the image to a segmentation model and receive, from the segmentation model, a respective segment of each object of the plurality of objects in the image.

Aspect 4. The apparatus of any one of aspects 1 to 3, wherein to determine the plurality of objects in the image, the at least one processor is configured to generate a plurality of masks, wherein each mask of the plurality of masks indicates pixels of the image that represent a respective object of the plurality of objects.

Aspect 5. The apparatus of aspect 4, wherein, to generate the plurality of masks, the at least one processor is configured to process the image using a segmentation machine-learning model, wherein the segmentation machine-learning model is trained to segment images.

Aspect 6. The apparatus of any one of aspects 1 to 5, wherein the at least one processor is configured to determine the set of patches for the image.

Aspect 7. The apparatus of aspect 6, wherein, to determine the set of patches for the image, the at least one processor is configured provide the image to at least one additional machine learning model and receive, from the at least one additional machine learning model, an identification of the set of patches.

Aspect 8. The apparatus of any one of aspects 1 to 7, wherein the image comprises pixels and wherein a patch of the set of patches represents one or more of the pixels.

Aspect 9. The apparatus of any one of aspects 1 to 8, wherein the object of interest is a main actionable object.

Aspect 10. The apparatus of any one of aspects 1 to 9, wherein the object of interest is configured to be controlled by the output content.

Aspect 11. The apparatus of any one of aspects 1 to 10, wherein the at least one processor is configured to determine a particular object of the plurality of objects as the object of interest.

Aspect 12. The apparatus of aspect 11, wherein the at least one processor is configured to determine the particular object of the plurality of objects as the object of interest based on user input indicating the particular object as the object of interest.

Aspect 13. The apparatus of any one of aspects 1 to 12, wherein, to identify the first subset of patches, the at least one processor is configured to select the first subset of patches from among the set of patches based on a position of the object of interest in the scene.

Aspect 14. The apparatus of aspect 13, wherein the at least one processor is configured to determine the position of the object of interest in the scene based on at least one of sensor data or command and control data.

Aspect 15. The apparatus of any one of aspects 1 to 14, wherein the output content corresponds to an action executable by an external device.

Aspect 16. The apparatus of any one of aspects 1 to 15, wherein the output content comprises instructions, and wherein the instructions comprise one or more measurements of movement, angle, or grip.

Aspect 17. The apparatus of any one of aspects 1 to 16, wherein, to extract the features from each patch of the first subset of patches, the at least one processor is configured to process each patch of the first subset of patches using an image-encoder machine-learning model, wherein the image-encoder machine-learning model is configured to generate image features based on images.

Aspect 18. The apparatus of any one of aspects 1 to 17, wherein, to extract the features from each patch of the first subset of patches, the at least one processor is configured to process each patch of the first subset of patches using two or more image-encoder machine-learning models, wherein each image-encoder machine-learning model of the two or more image-encoder machine-learning models is configured to generate image features based on images.

Aspect 19. The apparatus of any one of aspects 1 to 18, wherein the at least one processor is configured to: identify a plurality of subsets of patches from the set of patches, wherein each subset of patches of the plurality of subsets of patches comprises a respective number of patches, and wherein each subset of patches of the plurality of subsets of patches corresponds to a respective object of the plurality of objects; extract respective features from each patch of each subset of patches of the plurality of subsets of patches; combine the respective extracted features from each subset of patches of the plurality of subsets of patches to generate a plurality of sets of combined visual tokens, wherein each set of combined visual tokens corresponds to one of the plurality of subsets of patches; and provide the plurality of sets of combined visual tokens to the machine learning model to generate output content.

Aspect 20. The apparatus of aspect 19, wherein the plurality of subsets of patches comprises a predetermined count of subsets of patches.

Aspect 21. The apparatus of any one of aspects 1 to 20, wherein, to combine the extracted features from each patch of the second subset of patches, the at least one processor is configured to determine an average value for the extracted features.

Aspect 22. The apparatus of any one of aspects 1 to 21, wherein, to combine the extracted features from each patch of the second subset of patches, the at least one processor is configured to use at least one of max-pooling, average-pooling, attention pooling, or a transformer model on the extracted features.

Aspect 23. The apparatus of any one of aspects 1 to 22, wherein the at least one processor is configured to adjust the visual tokens representing the object of interest and the combined visual token representing the additional object to be suitable for the machine learning model.

Aspect 24. The apparatus of any one of aspects 1 to 23, wherein the at least one processor is configured to project the visual tokens representing the object of interest and the combined visual token representing the additional object from an image-embedding space to a text-embedding space.

Aspect 25. The apparatus of any one of aspects 1 to 24, wherein the at least one processor is configured to: identify a plurality of subsets of patches based on a plurality of images of the object of interest, wherein each subset of patches corresponds to a respective image of the plurality of images, wherein the plurality of subsets of patches corresponds to the object of interest; extract features from the plurality of subsets of patches to generate a plurality of visual tokens representing the object of interest, wherein each subset of patches corresponds to a respective visual token of the plurality of visual tokens; combine the plurality of visual tokens to generate a combined visual token representing the object of interest; and provide the combined visual token representing the object of interest to the machine learning model to generate the output content.

Aspect 26. The apparatus of any one of aspects 1 to 25, wherein the at least one processor is configured to: identify a plurality of subsets of patches based on a plurality of images of the additional object, wherein each subset of patches corresponds to a respective image of the plurality of images, wherein the plurality of subsets of patches corresponds to the additional object; extract features from the plurality of subsets of patches to generate a plurality of visual tokens representing the additional object, wherein each subset of patches corresponds to a respective visual token of the plurality of visual tokens; combine the extracted features from plurality of subsets of patches to generate a second combined visual token representing the additional object; and provide the second combined visual token representing the additional object to the machine learning model to generate the output content.

Aspect 27. The apparatus of any one of aspects 1 to 26, wherein the machine learning model comprises a large language model.

Aspect 28. The apparatus of aspect 27, wherein: the at least one processor is configured to provide text tokens based on instructions to the large language model; and the large language model is configured to generate the output content based on the visual tokens representing the object of interest, the combined visual token representing the additional object, and the text tokens.

Aspect 29. The apparatus of any one of aspects 1 to 28, wherein the output content comprises a control signal for controlling operation of a component.

Aspect 30. The apparatus of aspect 29, wherein the component comprises at least one of: an actuator, a solenoid, a motor, a valve, or an electromagnet.

Aspect 31. A method for generating content, the method comprising: determining a plurality of objects in an image of a scene; identifying a first subset of patches from a set of patches of the image that corresponds to an object of interest from the plurality of objects; extracting features from each patch of the first subset of patches corresponding to the object of interest to generate visual tokens representing the object of interest, wherein the visual tokens include a respective visual token for each patch of the first subset of patches; identifying a second subset of patches from the set of patches that corresponds to an additional object of the plurality of objects; extracting features from each patch of the second subset of patches corresponding to the additional object; combining the extracted features from each patch of the second subset of patches to generate a combined visual token representing the additional object; and providing the visual tokens representing the object of interest and the combined visual token representing the additional object to a machine learning model to generate output content.

Aspect 32. The method of aspect 31, further comprising performing segmentation of the image to determine the plurality of objects in the scene.

Aspect 33. The method of aspect 32, wherein performing the segmentation of the image comprises providing the image to a segmentation model and receiving, from the segmentation model, a respective segment of each object of the plurality of objects in the image.

Aspect 34. The method of any one of aspects 31 to 33, wherein determining the plurality of objects in the image comprises generating a plurality of masks, wherein each mask of the plurality of masks indicates pixels of the image that represent a respective object of the plurality of objects.

Aspect 35. The method of aspect 34, wherein generating the plurality of masks comprises processing the image using a segmentation machine-learning model, wherein the segmentation machine-learning model is trained to segment images.

Aspect 36. The method of any one of aspects 31 to 35, further comprising determining the set of patches for the image.

Aspect 37. The method of aspect 36, wherein determining the set of patches for the image comprises providing the image to at least one additional machine learning model and receiving, from the at least one additional machine learning model, an identification of the set of patches.

Aspect 38. The method of any one of aspects 31 to 37, wherein the image comprises pixels and wherein a patch of the set of patches represents one or more of the pixels.

Aspect 39. The method of any one of aspects 31 to 38, wherein the object of interest is a main actionable object.

Aspect 40. The method of any one of aspects 31 to 39, wherein the object of interest is configured to be controlled by the output content.

Aspect 41. The method of any one of aspects 31 to 40, further comprising determining a particular object of the plurality of objects as the object of interest.

Aspect 42. The method of aspect 41, further comprising determining the particular object of the plurality of objects as the object of interest based on user input indicating the particular object as the object of interest.

Aspect 43. The method of any one of aspects 31 to 42, wherein identifying the first subset of patches comprises selecting the first subset of patches from among the set of patches based on a position of the object of interest in the scene.

Aspect 44. The method of aspect 43, further comprising determining the position of the object of interest in the scene based on at least one of sensor data or command and control data.

Aspect 45. The method of any one of aspects 31 to 44, wherein the output content corresponds to an action executable by an external device.

Aspect 46. The method of any one of aspects 31 to 45, wherein the output content comprises instructions, and wherein the instructions comprise one or more measurements of movement, angle, or grip.

Aspect 47. The method of any one of aspects 31 to 46, wherein, extracting the features from each patch of the first subset of patches comprises processing each patch of the first subset of patches using an image-encoder machine-learning model, wherein the image-encoder machine-learning model is configured to generate image features based on images.

Aspect 48. The method of any one of aspects 31 to 47, wherein, extracting the features from each patch of the first subset of patches comprises processing each patch of the first subset of patches using two or more image-encoder machine-learning models, wherein each image-encoder machine-learning model of the two or more image-encoder machine-learning models is configured to generate image features based on images.

Aspect 49. The method of any one of aspects 31 to 48, further comprising: identifying a plurality of subsets of patches from the set of patches, wherein each subset of patches of the plurality of subsets of patches comprises a respective number of patches, and wherein each subset of patches of the plurality of subsets of patches corresponds to a respective object of the plurality of objects; extracting respective features from each patch of each subset of patches of the plurality of subsets of patches; combining the respective extracted features from each subset of patches of the plurality of subsets of patches to generate a plurality of sets of combined visual tokens, wherein each set of combined visual tokens corresponds to one of the plurality of subsets of patches; and providing the plurality of sets of combined visual tokens to the machine learning model to generate output content.

Aspect 50. The method of aspect 49, wherein the plurality of subsets of patches comprises a predetermined count of subsets of patches.

Aspect 51. The method of any one of aspects 31 to 50, wherein combining the extracted features from each patch of the second subset of patches, comprises determining an average value for the extracted features.

Aspect 52. The method of any one of aspects 31 to 51, wherein combining the extracted features from each patch of the second subset of patches comprises using at least one of max-pooling, average-pooling, attention pooling, or a transformer model on the extracted features.

Aspect 53. The method of any one of aspects 31 to 52, further comprising adjusting the visual tokens representing the object of interest and the combined visual token representing the additional object to be suitable for the machine learning model.

Aspect 54. The method of any one of aspects 31 to 53, wherein further comprising projecting the visual tokens representing the object of interest and the combined visual token representing the additional object from an image-embedding space to a text-embedding space.

Aspect 55. The method of any one of aspects 31 to 54, further comprising: identifying a plurality of subsets of patches based on a plurality of images of the object of interest, wherein each subset of patches corresponds to a respective image of the plurality of images, wherein the plurality of subsets of patches corresponds to the object of interest; extracting features from the plurality of subsets of patches to generate a plurality of visual tokens representing the object of interest, wherein each subset of patches corresponds to a respective visual token of the plurality of visual tokens; combining the plurality of visual tokens to generate a combined visual token representing the object of interest; and providing the combined visual token representing the object of interest to the machine learning model to generate the output content.

Aspect 56. The method of any one of aspects 31 to 55, further comprising: identifying a plurality of subsets of patches based on a plurality of images of the additional object, wherein each subset of patches corresponds to a respective image of the plurality of images, wherein the plurality of subsets of patches corresponds to the additional object; extracting features from the plurality of subsets of patches to generate a plurality of visual tokens representing the additional object, wherein each subset of patches corresponds to a respective visual token of the plurality of visual tokens; combining the extracted features from plurality of subsets of patches to generate a second combined visual token representing the additional object; and providing the second combined visual token representing the additional object to the machine learning model to generate the output content.

Aspect 57. The method of any one of aspects 31 to 56, wherein the machine learning model comprises a large language model.

Aspect 58. The method of aspect 57, further comprising providing text tokens based on instructions to the large language model, wherein the large language model is configured to generate the output content based on the visual tokens representing the object of interest, the combined visual token representing the additional object, and the text tokens.

Aspect 59. The method of any one of aspects 31 to 58, wherein the output content comprises a control signal for controlling operation of a component.

Aspect 60. The method of aspect 59, wherein the component comprises at least one of: an actuator, a solenoid, a motor, a valve, or an electromagnet.

Aspect 61. A non-transitory computer-readable storage medium having stored thereon instructions that, when executed by at least one processor, cause the at least one processor to perform operations according to any of aspects 31 to 60.

Aspect 62. An apparatus, the apparatus comprising one or more means for performing operations according to any of aspects 31 to 60.

What is claimed is:

1. An apparatus for generating content, the apparatus comprising:
at least one memory; and
at least one processor coupled to the at least one memory and configured to:
determine a plurality of objects in an image of a scene;
identify a first subset of patches from a set of patches of the image that corresponds to an object of interest from the plurality of objects;
extract features from each patch of the first subset of patches corresponding to the object of interest to generate visual tokens representing the object of interest, wherein the visual tokens include a respective visual token for each patch of the first subset of patches;
identify a second subset of patches from the set of patches that corresponds to an additional object of the plurality of objects;
extract features from each patch of the second subset of patches corresponding to the additional object;
combine the extracted features from each patch of the second subset of patches to generate a combined visual token representing the additional object; and
provide the visual tokens representing the object of interest and the combined visual token representing the additional object to a machine learning model to generate output content.

2. The apparatus of claim 1, wherein to determine the plurality of objects in the image, the at least one processor is configured to generate a plurality of masks, wherein each mask of the plurality of masks indicates pixels of the image that represent a respective object of the plurality of objects.

3. The apparatus of claim 1, wherein the object of interest is a main actionable object.

4. The apparatus of claim 1, wherein the object of interest is configured to be controlled by the output content.

5. The apparatus of claim 1, wherein the at least one processor is configured to determine a particular object of the plurality of objects as the object of interest.

6. The apparatus of claim 5, wherein the at least one processor is configured to determine the particular object of the plurality of objects as the object of interest based on user input indicating the particular object as the object of interest.

7. The apparatus of claim 1, wherein, to identify the first subset of patches, the at least one processor is configured to select the first subset of patches from among the set of patches based on a position of the object of interest in the scene.

8. The apparatus of claim 7, wherein the at least one processor is configured to determine the position of the object of interest in the scene based on at least one of sensor data or command and control data.

9. The apparatus of claim 1, wherein the output content corresponds to an action executable by an external device.

10. The apparatus of claim 1, wherein the output content comprises instructions, and wherein the instructions comprise one or more measurements of movement, angle, or grip.

11. The apparatus of claim 1, wherein, to extract the features from each patch of the first subset of patches, the at least one processor is configured to process each patch of the first subset of patches using an image-encoder machine-learning model, wherein the image-encoder machine-learning model is configured to generate image features based on images.

12. The apparatus of claim 1, wherein, to extract the features from each patch of the first subset of patches, the at least one processor is configured to process each patch of the first subset of patches using two or more image-encoder machine-learning models, wherein each image-encoder machine-learning model of the two or more image-encoder machine-learning models is configured to generate image features based on images.

13. The apparatus of claim 1, wherein the at least one processor is configured to:
identify a plurality of subsets of patches from the set of patches, wherein each subset of patches of the plurality of subsets of patches comprises a respective number of patches, and wherein each subset of patches of the plurality of subsets of patches corresponds to a respective object of the plurality of objects;
extract respective features from each patch of each subset of patches of the plurality of subsets of patches;
combine the respective extracted features from each subset of patches of the plurality of subsets of patches to generate a plurality of sets of combined visual tokens, wherein each set of combined visual tokens corresponds to one of the plurality of subsets of patches; and
provide the plurality of sets of combined visual tokens to the machine learning model to generate output content.

14. The apparatus of claim 1, wherein, to combine the extracted features from each patch of the second subset of patches, the at least one processor is configured to determine an average value for the extracted features.

15. The apparatus of claim 1, wherein, to combine the extracted features from each patch of the second subset of patches, the at least one processor is configured to use at least one of max-pooling, average-pooling, attention pooling, or a transformer model on the extracted features.

16. The apparatus of claim 1, wherein the at least one processor is configured to adjust the visual tokens representing the object of interest and the combined visual token representing the additional object to be suitable for the machine learning model.

17. The apparatus of claim 1, wherein the at least one processor is configured to:
identify a plurality of subsets of patches based on a plurality of images of the object of interest, wherein each subset of patches corresponds to a respective image of the plurality of images, wherein the plurality of subsets of patches corresponds to the object of interest;
extract features from the plurality of subsets of patches to generate a plurality of visual tokens representing the object of interest, wherein each subset of patches corresponds to a respective visual token of the plurality of visual tokens;
combine the plurality of visual tokens to generate a combined visual token representing the object of interest; and
provide the combined visual token representing the object of interest to the machine learning model to generate the output content.

18. The apparatus of claim 1, wherein the at least one processor is configured to:
identify a plurality of subsets of patches based on a plurality of images of the additional object, wherein each subset of patches corresponds to a respective image of the plurality of images, wherein the plurality of subsets of patches corresponds to the additional object;
extract features from the plurality of subsets of patches to generate a plurality of visual tokens representing the additional object, wherein each subset of patches corresponds to a respective visual token of the plurality of visual tokens;
combine the extracted features from plurality of subsets of patches to generate a second combined visual token representing the additional object; and
provide the second combined visual token representing the additional object to the machine learning model to generate the output content.

19. The apparatus of claim 1, wherein:
the machine learning model comprises a large language model;
the at least one processor is configured to provide text tokens based on instructions to the large language model; and
the large language model is configured to generate the output content based on the visual tokens representing the object of interest, the combined visual token representing the additional object, and the text tokens.

20. The apparatus of claim 1, wherein the output content comprises a control signal for controlling operation of at least one of:
an actuator,
a solenoid,
a motor,
a valve, or
an electromagnet.
